(19) United States
(12) Patent Application Publication
(10) Pub. No.: US 2024/0235858 A9
(43) Pub. Date: Jul. 11, 2024

(54) COMPUTE DEVICE WITH ANTENNA COMBINATION

(71) Applicant: NOODLE TECHNOLOGY, INC, San Francisco, CA (US)

(72) Inventors: Garrett Edward Kinsman, San Francisco, CA (US); Lucien Jean Baptiste Loiseau, San Francisco, CA (US); Eliott Quentin Eric Teissonniere, San Francisco, CA (US); Micha Anthenor Benoliel, San Francisco, CA (US)

(73) Assignee: NOODLE TECHNOLOGY, INC, San Francisco, CA (US)

(21) Appl. No.: 18/547,140

(22) PCT Filed: Feb. 19, 2022
(86) PCT No.: PCT/US2022/017112

§ 371 Date: Aug. 18, 2023

Related U.S. Application Data
(60) Provisional application No. 63/151,512, filed on Feb. 19, 2021.
(60) Provisional application No. 63/160,902, filed on Mar. 14, 2021.

(51) Int. Cl. H04L 9/40; H01Q 1/24; H04L 9/08

(52) U.S. Cl. CPC H04L 9/40; H01Q 1/246; H04L 9/0861

(57) ABSTRACT

A compute device includes: a substrate; a circuit trace that is coupled to electronic components, wherein the electronic components include at least a processor, memory, and transceiver; a power source (battery and/or solar element) coupled with the electronic components; an antenna layer over the substrate that has at least one primary antenna element of at least one antenna assembly, wherein each antenna assembly is operationally coupled with the transceiver as a data communication link, and each primary antenna element is operationally coupled to the electronic components or power source as a structure of at least one ground plane for the respective primary antenna element; and a coupling member configured for being coupled to an object. In some aspects, the power source is selected from a, battery, solar element, or combinations thereof.

### CROSS-REFERENCE TO RELATED APPLICATIONS

This patent application claims priority to U.S. Provisional Application No. 63/151,512 filed Feb. 19, 2021 and claims priority to U.S. Provisional Application No. 63/160,902 filed Mar. 14, 2021, which provisional applications are incorporated herein by specific reference in its entirety.

### BACKGROUND

### Field

The present disclosure relates to a compute device with an antenna combination that includes at least one primary antenna element operably coupled to at least one other electronic component that services as a ground plane for the at least one primary antenna element.

### Description of Related Art

Data communication networks have been established to allow for passing data between electronic devices, which can include a sending device transmitting data over the network to a receiving device. An exemplary network includes the Internet, which is a global network of smaller interconnected networks. Many local networks are established with many of the network devices being in fixed locations, such as base stations, routers, antenna towers, and the like. Due to the nature of fixed location devices that serve as the hub of network communications, there is little flexibility in coverage of a local network. However, mesh networks, distributed networks, and ad hoc networks are known to be useful.

A mesh network is a network in which devices, also called nodes, are linked together in a way such that each device can be part of a branch extending off other branches formed by devices or nodes. These networks are set up to efficiently route data between devices and clients. The mesh network can be configured to provide a consistent connection throughout a physical space.

Distributed networks are part of distributed computing architecture, in which information technology infrastructure resources are divided over a number of networks, processors and intermediary devices and endpoint devices. A distributed network is often operated by network management software, which manages and monitors data routing, combining and allocating network bandwidth, access control and other core networking processes. Distributed networks can use multiple compute devices processing data together to deliver specialized applications to different remote users. This means that an application may be hosted and executed from a single machine but accessed by many others. A client/server computing architecture is an example of a distributed network where the server is the producer of a resource and many interconnected remote users are the consumers who access the application from different networks. The distributed network can distribute networking tasks and data processing tasks across the nodes, which can include endpoint devices performing data processing for other devices in the network.

An ad hoc network is a decentralized type of wireless network. A network is considered to “ad hoc when it does not rely entirely on a pre-existing infrastructure, such as routers in wired networks or access points in wireless networks. Each device in an ad hoc network can be at a node, and each node can participate in facilitating data communications by forwarding data for other nodes. The ad hoc network can make determinations of which nodes forward data to which receiving nodes dynamically on the basis of network connectivity and the routing algorithm in use. An ad hoc communication mode allows computers to directly communicate with each other without a router. Wireless mobile ad hoc networks are self-configuring, dynamic networks in which nodes are free to move. Such ad hoc wireless networks do not require complex infrastructure and administration, which allows for devices to create and join ad hoc networks “on the fly”.

The subject matter claimed herein is not limited to embodiments that solve any disadvantages or that operate only in environments such as those described above. Rather, this background is only provided to illustrate one example technology area where some embodiments described herein may be practiced.

### SUMMARY

In some embodiments, a compute device can include: a substrate; at least one circuit trace on the substrate that is electronically coupled to electronic components, wherein the electronic components include at least a processor, memory, and transceiver; at least one power source operationally coupled with the electronic components; at least one antenna layer over the substrate that has at least one primary antenna element of at least one antenna assembly, wherein each antenna assembly is operationally coupled with the transceiver as a data communication link, and each primary antenna element is operationally coupled to at least one of the electronic components or power source as a structure of at least one ground plane for the respective primary antenna element; and a coupling member configured for being coupled to an object. In some aspects, the power source is selected from a battery, solar element, or combinations thereof.

In some embodiments, a network can include at least one of the compute devices. Also, a network can include a plurality of compute devices as described herein.

In some embodiments, the compute device can be configured for performance of the methods described herein.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIGS. 1A-1D include cross-sectional views that illustrate embodiments of a compute device.

FIG. 2A includes an exploded perspective view of an embodiment of a compute device.

FIG. 2B includes a top view of a layer of the compute device of FIG. 2A.

FIG. 2C includes a top view of another layer of the compute device of FIG. 2A.

FIG. 3A includes a partially exploded perspective view of an embodiment of a compute device.

FIG. 3B includes a cross-sectional view of the compute device of FIG. 3A.

FIG. 4 includes a perspective view of an embodiment of a compute device.

FIG. 5 includes a schematic representation of hardware of an embodiment of a compute device.

FIG. 6 includes a schematic representation of a computing device that can be used as a compute device.

FIG. 7 includes a schematic representation of a network having a compute device as a network component.

FIG. 8A includes illustrations of objects that can include a compute device coupled therewith.

FIG. 8B includes illustrations of vehicle objects that can include a compute device coupled therewith.

FIG. 8C includes illustrations of an environment having a plurality of the compute devices attached to objects and forming a network.

The elements and components in the figures can be arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the present technology is related to a compute device that is configured with computer components to form a fully operable and programmable compute device that has an antenna assembly for data communications and/or signal harvesting. The antenna assembly can include a primary antenna element and, in some embodiments, at least one secondary antenna element that is operably coupled with the primary antenna element. The primary antenna element can be a dedicated antenna member with a fixed shape and size that is configured for an intended use. The secondary antenna element is an electronically-conducting member of another component of the device, such as an electronic component with at least a portion thereof being electronically-conductive. In one example, a battery of the compute device can be used as the first antenna element and/or the second antenna element. In another example, a solar panel element can be used as the first antenna element and/or the second antenna element. In another example, the compute device can be configured to use the battery and/or the solar panel element as the first antenna element and/or the second antenna element. In another example, the other of the battery or solar panel element can be yet a third antenna element. The compute device can include electronics, firmware, hardware, and/or software configured to control the operation of the antenna assembly, such as by controlling the component that is the second antenna element, and possibly of both the second and third antenna elements. This allows for the antenna assembly to be dynamically variable and can be configured for beamforming. However, the antenna assembly can be set with a fixed primary antenna and a fixed secondary antenna, and optionally a fixed third antenna. This provides options for the antenna assembly and uses of the compute device.

In some embodiments, the antenna assembly includes the primary antenna element as a dedicated antenna member. The antenna assembly also includes a ground plane for the primary antenna element. This ground plane can be the electrically conductive component of the compute device. For example, the battery can be the ground plane for the primary antenna element. In another example, the solar panel element can be the ground plane for the primary antenna element. In yet another example, the battery and/or solar panel element can be the ground plane for the primary antenna element.

In some embodiments, the primary antenna element can be optically transmissive, such as by being optically transparent or translucent, so that light can pass through to the solar panel, such as when stacked. The material can be a transparent conductive material, such as transparent conductive oxides or polymers, such as clear Kapton polyimide film, but can be clear PEEK or transparent conductive polyester film. The antenna can be a meshed antenna which includes an edge or border of the shape with an open interior, which allows light to pass through, even when the border is non-translucent metal. An example can include ink-jetting silver conductive ink on transparent PET or polyamide film; however, other conductive inks can be used.

In some embodiments, the antenna assembly can be a patch or microstrip type of antenna assembly. The patch antenna assembly can include elements of one or more primary antenna elements (e.g., metal sheets) mounted over a ground plane of the other component of the compute device, such as battery or solar panel element. The configuration of the patch antenna allows it to be integrated into the small form factor compute device provided herein. The patch antenna assembly allows for easy fabrication using printed circuit board (PCB) techniques. The patch antenna assembly allows the compute device to be used as a modern wireless devices. Also, the patch antenna allows for the antenna assembly to include an array of antennas, or there can be an array of individual antenna assemblies that are each configured as described herein. Transparent conductive oxides can also be deposited on a clear substrate, such as PT or polyamide, where the oxides include indium tin oxide, zinc oxide, tin oxide, or combinations thereof. Also, 5G transparent antenna materials may be used, such as nanoweb materials (e.g., transparent metal mesh), Dongwoo Fine-Chem transparent antenna (mmWave, antenna on display), transparent conducting films, graphene film, or others. Conductive vapor deposition coatings can also be used to form the conductive antenna element. The compute device can include any number of antennas, which may be different antenna assemblies for different uses. As such, the compute device can include “N” number of unique antennas or antenna assemblies, where N is an integer. For example, many microwave antennas have a high number of antennas, such as in the hundreds. Accordingly, a compute device configured as described herein can support hundreds to thousands of unique antennas or antenna assemblies.

Additionally, the compute device is configured with a small footprint and a coupling feature that allows for being attached to fixed location objects, such as trees, buildings, or other natural or manmade structures. The compute device can include any type of coupling feature, such as an adhesive surface, magnetic surface (e.g., attach to magnetically-responsive materials), hook and loop fasteners (e.g., one of the hook member or loop member on the device, Velcro®) or the like. Also, a mechanical coupling feature can be used that includes a member to receive a fastener member (e.g., bolt, nail, screw, dowel, wire, rope, tie, etc.) therethrough, such as by having a flange or other fastener-receiving member with a through hole. These types of coupling or fastening configurations allow for the compute device to be mounted to about any object with difficulty of being removed, so as to appear to be permanent (e.g., adhesive, nailed, screwed, etc.) or removable (e.g., Velcro, wire, rope, tie, etc.). However, it is recognized that any of the fastening configurations to be undone so that the compute device can be removed, and some configurations are more difficult to remove (e.g., adhesive, nailed, screwed, etc.) than others (e.g., Velcro, wire, rope, tie, etc.).

In some embodiments, the compute device includes a flexible substrate. This allows for the compute device to be flexible so that it can bend in any direction. For example, the substrate of the compute device can be flat when on another flat surface; however, the substrate can bend to conform with a curved or irregular surface. The flexible substrate allows for mounting to flat external surfaces of buildings, rounded utility poles, trees, boulders, or other structures, whether on a flat or curved surface. The flexible substrate can be configured similarly to flexible electronics, which can be known as flex circuits, which includes assembling electronic circuits by mounting electronic devices on flexible plastic substrates, such as polyimide, PEEK or transparent conductive polyester film. Additionally, flex circuits can be screen printed silver circuits on polyester. Flexible electronic assemblies of the compute device described herein may be manufactured using identical components used for rigid printed circuit boards, allowing the board to conform to a desired shape, or to flex during its use. Flexible printed circuits (FPC can be made with a photolithographic technology. An alternative way of making flexible foil circuits or flexible flat cables (FFCs) is laminating very thin (e.g., 0.07 mm) copper strips in between two layers of polyethylene terephthalate (PET). These PET layers (e.g., 0.05 mm thick) are coated with an adhesive which is thermosetting, and will be activated during the lamination process.

The flexible substrate allows for the compute device to be foldable and flexible. The foldability from the flexible substrate allows the folding to decrease its surface area that is directly exposed to the sun. The flexibility also allows for the compute device to be attached to curved surfaces or easily added to a building wall surface. Also, the flexibility also allows for the compute device to be temporarily attached to an object, such as a construction equipment or structure, or even on a mobile vehicle. The compute device, for example, may be folded such that a first portion is exposed to the sun, and a second portion may be folded at a different angle with respect to the sun as compared to the first portion (e.g., the first portion can include the solar panel and the second portion can include the battery or operational electronic components. Accordingly, the compute device may be folded into any shape, such as into an object (e.g., flower), for any reason. For example, the compute device can be folded into a shape of a natural object to function as camouflage or a disguise for the compute device, or such that the compute device may blend in with a surrounding environment (e.g., nature).

In some embodiments, the compute device can include a rigid substrate. While some embodiments may include the compute device being flexible and bendable, other embodiments are fixed shaped and rigid, such as using standard silicon PCB or other rigid substrate for electronics.

In some embodiments, the compute device is battery powered. In some aspects, the battery operates the compute device without an electrical line to an external power supply, such as a common wall outlet. In some aspects, the battery is a rechargeable battery and the compute device includes a power charging port, which is well known for battery-powered electronic devices. In some aspects, the battery is not rechargeable and the compute device dies once the battery is dead, unless the dead battery is physically removed and replaced by a new battery. In some aspects, the battery is configured to be replaceable. In some aspects, the compute device is devoid of a dedicated power port that provides electrical power from a power outlet to the device. However, a power port may be included in some embodiments for use where power is available. A recharging port for the battery is not a dedicated power port. Instead, the dedicated power port is configured to plug into a standard wall outlet to receive power and operate the device, which can be omitted in some aspects and included in others.

In some embodiments, the battery is flexible, and configured for some degree of bendability instead of being rigidly planar or rigidly structured. The battery is made of one or several galvanic cells, where each cell includes a cathode, anode, separator, and in many cases current collectors. In flexible batteries, all these components are prepared to be flexible. These batteries can be fabricated into different shapes and sizes and by different methods. Polymer binders can be used to fabricate composite electrodes where conductive additives are used to enhance their conductivity. The electrode materials can be printed or coated onto flexible substrates, which are often polymeric. The cells are assembled into flexible packaging materials to maintain bendability. In some aspects, filtering of electrode suspension through filters can be performed to form free-standing films. In some aspects, a flexible matrix can be used to hold electrode materials. A rechargeable battery example can include flexible lithium-ion batteries, which may include nanocarbons in flexible lithium-ion batteries, or Li₄Ti₅O₁₂ and LiFePO₄ as anode and cathode, with a flexible graphene-based current collector. Carbon nanotube electrodes, whether pristine, or combined with Li₄Ti₅O₁₂, LiCoO₂, or SnO₂. Also, the device can include a paper-thin flexible self-rechargeable battery that combines a thin-film organic solar cell with an extremely thin and highly flexible lithium-polymer battery, which recharges itself when exposed to light (where solar cell and/or flexible lithium-polymer batteries are flexible).

In some embodiments, the compute device can include a solar panel element for electricity harvesting from the sun. When the solar panel element is included, the compute device may include a battery or omit a battery. When omitting a battery, the compute device operates when the solar panel element provides the operating power. When including a battery, the solar panel element can provide operating power and to also charge (e.g., recharge) the battery. A solar cell panel, solar electric panel, photo-voltaic (PV) module or just solar panel is an assembly of photo-voltaic cells mounted in a framework for installation. Solar panels use sunlight as a source of energy to generate direct current electricity. A collection of PV modules is called a PV panel, and a system of PV panels is called an array. Arrays of a photovoltaic system supply solar electricity to electrical equipment. Flexible solar elements can include solar cells having photovoltaic material deposited on flexible substrates, such as those described herein to paper, using vapor deposition technology. Circuits of organic photovoltaic materials can be deposited in layers on a flexible substrate in a vacuum chamber. Coating conformal conductive polymer electrodes with oxidative chemical vapor is performed by chemical vapor deposition. The solar cell is also shown to be flexible.

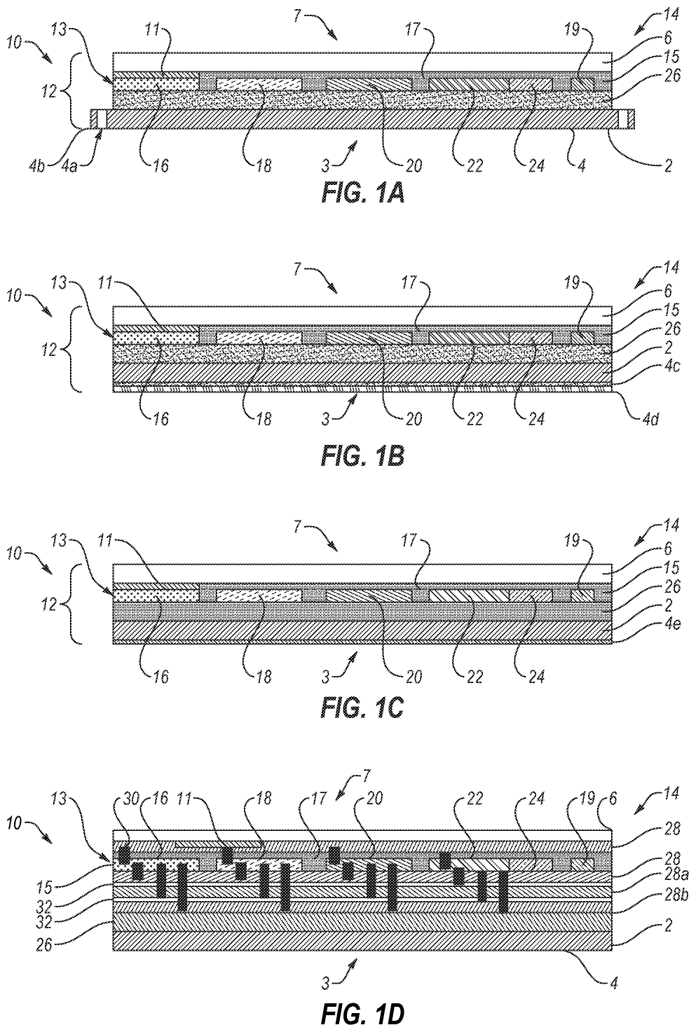

FIG. 1A is a cross-sectional view that illustrates an embodiment of a layered computing device 10 configured for operation in accordance with the present disclosure. A layered compute device 10 can include a plurality of layers 12 arranged in a stacked layer format 14. The plurality of layers 12 can include the features of the compute device. A coupling layer 2 can be provided that has at least one coupling member 4 configured to be coupled to an object. The coupling layer 2 is a first end 3 of the stacked layer format 14. A protective layer 6 is provided opposite of the coupling layer 2. The protective layer 6 is a second end 7 of the stacked layer format 14. The compute device 10 can include at least one compute layer 15 having compute components 13, such as electronics 17 that electronically connected to a processor 16, a memory 18, at least one antennae element 19, a transceiver 20, and at least one power source 22, wherein the at least one power source includes a solar element 22 and/or a battery 24. The compute components 13 can also include wireless radios, hardware modules, such as a system on a chip, neural network, chip, application specific integrated circuit (ASIC), microprocessor (e.g., running a full or real time operating system, such as FreeRTOS), memory storage (e.g., flash or RAM), hardware security modules, power management modules, solar charge controller, real-time clock (RTC) that can be synchronized by satellite (e.g., GPS, GLONASS, GALILEO, BeiDou, etc.) or internet network time (NTP), batter, and sensors 11. The compute components can be printed electronics, such as via the processes described herein or generally known.

The sensors 11 can be any type of sensors, such as those that do not use external stimuli that can be embedded in the compute device, or others that use external stimuli that have one or more ports in the protective layer 6 for receiving the external stimuli. Of course, when a light sensor, light can penetrate the optically transmissive protective layer 6 to an embedded light sensor.

Embedded sensors can include: flex sensor that determines amount of flex of the compute device; temperature sensor, motion sensor (e.g., gyroscope, accelerometer, etc.); compass; light sensor; or others.

Exposed sensors can include: humidity sensor; radiation sensor; light sensor; chemical sensor; gas sensor; liquid sensor; biological agent sensor; DNA sensor; protein sensor; or others.

In some embodiments, the compute device 10 can include one or more LED indicator lights, such as on the top or at a side, for showing operational status or data transmission status. These types of light indicators are readily available.

In some embodiments, the light sensor can be configured for receiving data transmission optical light, such as a laser. The light sensor can receive the optical data via the light for communications.

In some embodiments, the compute device 10 may include an additional antenna assembly, which is a third-party antenna array, such as trace or ceramic antenna. The additional antenna assembly can be used for communications other than for the configurable antenna assembly described herein that uses a conductive component as a ground plane.

In some embodiments, the compute device 10 can include any pluggable ports that are available, such as USB, USB-C, coaxial, power, fiber optics, or the like.

The compute components 13 can be on a single compute layer 15 or can be distributed over a plurality of compute layers 15. Each compute layer 15 may be separated by an insulating layer. Vias 30 (FIG. 1D) can be used to provide electronic connections between the layers. The compute device 10 can include at least one insulating substrate 26 positioned between the at least one compute layer 15 and the coupling layer 2. The material of the insulating substrate 26 can also be used as the insulating layer between compute layers 15.

The antennae element 19 can be the primary antenna element of an antenna assembly, such as a patch antenna assembly. The other electrically conductive components can be used as the ground plane for the antenna assembly, such as the solar element 22 and/or battery 24.

The coupling layer 2 may include wings 4b for use as a coupling member 4. This can allow for the wings 4b to be coupled to the object. The wings 4b may include fastener conduits 4a that can receive a fastener (e.g., nail, screw, prong, wire, dowel, tie or the like) therethrough and into the object. The conduits 4a may be threaded or smooth or include a friction coupling or a snap fit.

FIG. 1B is a cross-sectional view that illustrates another embodiment of a layered computing device 10 configured for operation in accordance with the present disclosure. The protective layer 6, compute layer 15, and insulating substrate 26 can be the same as in FIG. 1A; however, variations may be implemented. The coupling layer 2 in FIG. 1B is configured to be adhesive coupling member 4. The adhesive can be any type of adhesive that can be formed into a layer and bonded to an object to attach the compute device 10 thereto. Accordingly, the coupling member 4 may be embodied as an adhesive layer 4c as shown on the bottom of the coupling layer 2. The bottom surface at the first end 3 may be the adhesive layer 4c, which can be exposed when getting ready to apply the adhesive layer 4c to an object. The adhesive layer 4c can include a peelable release liner 4d thereover, which can be peeled off to release the adhesive layer 4c to be exposed for adhering to the object.

FIG. 1C is a cross-sectional view that illustrates another embodiment of a layered computing device 10 configured for operation in accordance with the present disclosure. The protective layer 6, compute layer 15, and insulating substrate 26 can be the same as in FIG. 1A. The coupling member 4 may be embodied as a magnetic layer 4e as shown on the bottom of the coupling layer 2. The bottom surface at the first end 3 may be the magnetic layer 4e, which can be exposed when getting ready to apply the layered compute device 10 to an object.

FIG. 1D is a cross-sectional view that illustrates another embodiment of a layered computing device 10 configured for operation in accordance with the present disclosure. The layered compute device 10 includes a plurality of layers 12 arranged in a stacked layer format 14. The plurality of layers 12 can include the coupling layer 2, protective layer 6, at least one compute layer 15, at least one conductive layer 28, and at least one insulating substrate 26. The coupling layer 2 can be configured to have at least one coupling member 4 configured to be coupled to an object as described herein. The coupling layer 2 has a first end 3 of the stacked layer format 14. The protective layer 6 is positioned opposite of the coupling layer 2, and thereby the protective layer 6 is a second end 7 of the stacked layer format 14. At least one compute layer 15 is provided that includes compute components 13, such as electronics 17 electronically connected to a processor 16, a memory 18, at least one antennae element 19, a transceiver 20, and at least one power source, wherein the at least one power source includes a solar panel 22 and/or a battery 24. At least one conductive layer 28,28a,28b is provided, which is electronically coupled with the electronics 14 of the at least one compute layer 15 and to any of the components thereof at least one insulating substrate 26 positioned between the at least one compute layer 15 and the coupling layer 2. A sensor 11 is also shown.

Each conductive layer 28,28a,28b can include one or more layers of conductive traces, battery anode, battery cathode, solar panel element, or antenna element, and combinations thereof. A conductive layer 28 can be positioned adjacent to one or more compute layers 15. A conductive layer 28 can be between a compute layer 15 and the protective layer. A conductive layer 28 can be between a compute layer and the coupling layer 2. In some aspects, one of the conductive layers 28 is the primary antennae element. In some aspects, one of the conducive layers 28 is a battery element or a solar element, which is configured to be the ground plane for the antenna assembly.

The layered compute device 10 can include a via 30 to electronically couple the electronics 17 of each compute layer 15 to components in one of the conductive layers 28,28a,28b. The vias 30 can be from the electronics 17 electronically connected to a processor 16, a memory 18, at least one antennae element 19, a transceiver 20, and/or at least one power source 22 to the conductive layer 28. The conductive traces, battery anode, battery cathode, solar panel element, or antenna element of the conductive layer 28 can be coupled with the electronics 17 or processor 16, a memory 18, at least one antennae element 19, a transceiver 20. Additionally, an insulation layer 32 can be positioned between each compute layer 15 and a conductive layer 28. Also, there may be multiple conductive layers 28 above the compute layer 15, each separated by an insulation layer 32. Additionally, there may be multiple conductive layers 28a, 28b below the compute layer 15, each separated by an insulation layer 32. The insulation substrate 26 may be an insulating layer 32, as described herein.

In FIG. 1D additional conductive layers 28,28a,28b can be included with or without the insulation layers 32. The conductive layers 28,28a,28b can have the compute components 13 of the compute layer 15. As such, instead of the compute layer 15 including all of the electronics 17 electronically connected to a processor 16, a memory 18, at least one antennae element 19, a transceiver 20, solar element 22 and/or a battery 24, one or more of these components can be on an individual conductive layer 28,28a,28b. In an example, each compute component 13 can be on its own conductive layer 28,28a,28b.

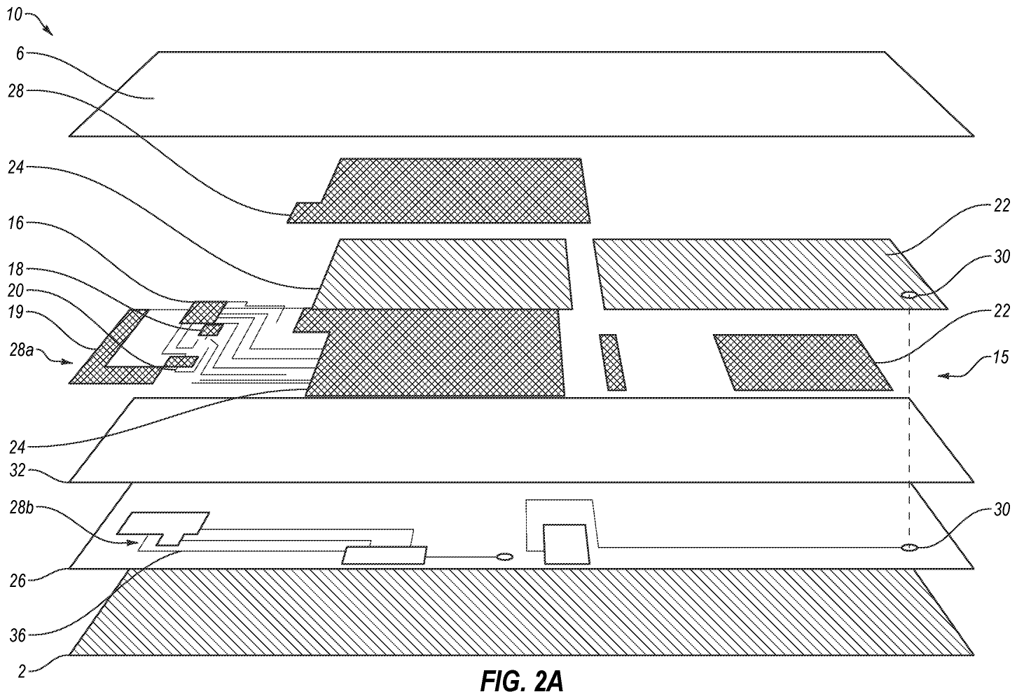

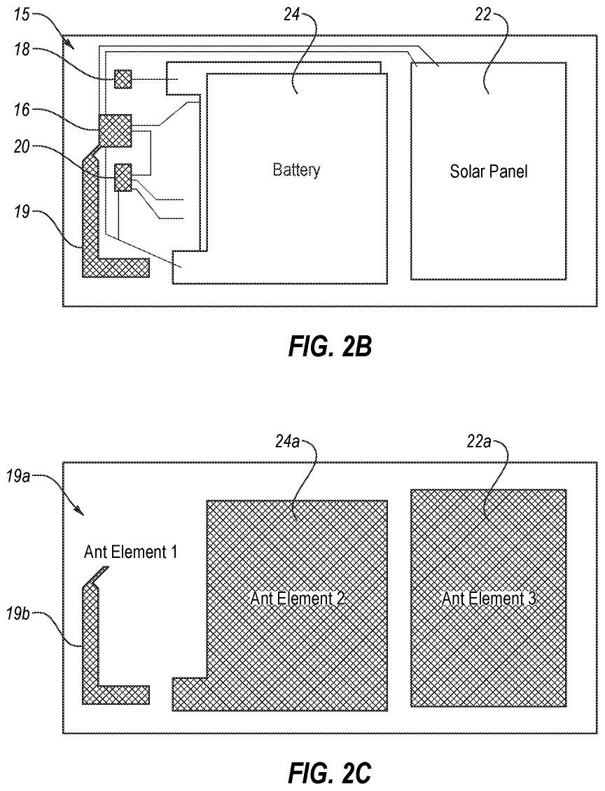

FIG. 2A is an exploded perspective view that illustrates another embodiment of a layered computing device 10 configured for operation in accordance with the present disclosure. The plurality of layers are illustrated to see the contents in perspective view. As shown, the coupling layer 2 has an insulating substrate 26 positioned thereon. A conductive layer 28b is on the insulating substrate 26, where the conductive layer 28b can include the electronic traces 36 with or without vias 30. An insulation layer 32 is over the conductive layer 28b. Another conductive layer 28a can be over the insulation layer 32. The conductive layer 28a can include the electronic traces 36 connecting the surface mounted components, which can be mounted on the conductive layer 28a. The surface mounted components can be the compute components 13, which can include a sensor 11, processor 16, a memory 18, at least one antennae element 19, a transceiver 20, and/or at least one power source. The battery 24 and solar element 22 are also shown. The battery 24 can include a printed or fixed battery element, such as an anode or cathode. The solar element 22 can include a printed or fixed solar element having one or more solar panels. It should be noted that any of the conductive layers 28,28a,28b can include one or more layers (e.g., n layers, where n is an integer) of conductive traces, battery anode, and or battery cathode, or the like. Any of the conductive layers 28,28a,28b can include one or more layers (e.g., n layers, where n is an integer) of processor 16, a memory 18, at least one antennae element 19, a transceiver 20, and/or at least one power source, such as battery 24 and/or solar element 22. The vias 30 can be used for making electronic couplings between the different layers, such as the conductive layers 28,28a,29b and compute layer 15.

Additionally, insulation layers 32 may bound any of the compute layers 15 or conductive layers 28,28a,28b. The insulation layers 32 can allow for printing the electronics thereon for formation of the appropriate layer. Also, the insulation layers 32 can facilitate the stack layering.

The power source can also include a solar element 22, which can include at least one solar panel. The solar element 22 can include elements to convert light into electricity. Solar panels are use thereof for generating electricity for devices is well known, and thereby can be implemented in this invention.

FIG. 2B shows a top view of an example embodiment of a compute layer 15. The compute layer 15 is shown to have the processor 16, a memory 18, at least one antennae element 19, a transceiver 20, and/or at least one power source, such as the battery 24 and solar element 22. However, only the battery can be included in the compute layer 15 in some embodiments where the solar element 22 is omitted, and vice versa.

FIG. 2C shows a top view of an example embodiment of an antenna element layer 19a, which can be used for any of the conductive layers 28,28a,28b. The antenna element layer 19a can include a first antenna component 19b along with a second antenna component 24a and a third antenna component 22a (which may be omitted when there is no solar element 22). The first antenna component 19b can be a primary antenna. While the second antenna component 24a and the third antenna component may also be configured to be a primary antenna, these two antenna components can be configured as an antenna ground plane of the configurable antenna assembly. As such, this shows that a layer of the battery 24 can be configured into a second antenna component 24a that is a ground plane for the first antenna component 19b. Additionally, this shows that a layer of the solar element 22 can be configured into a third antenna component 22a that is a ground plane for the first antenna component 19b.

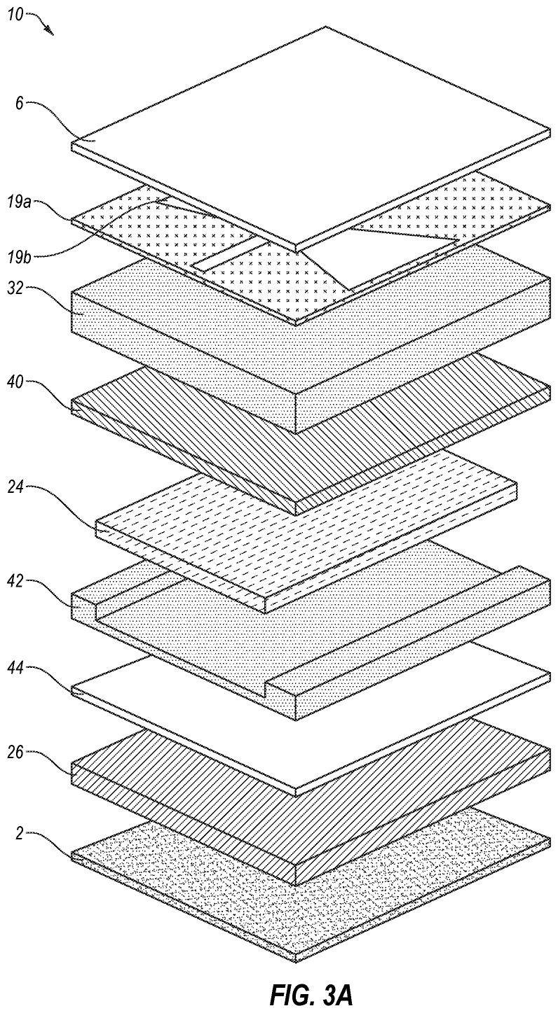

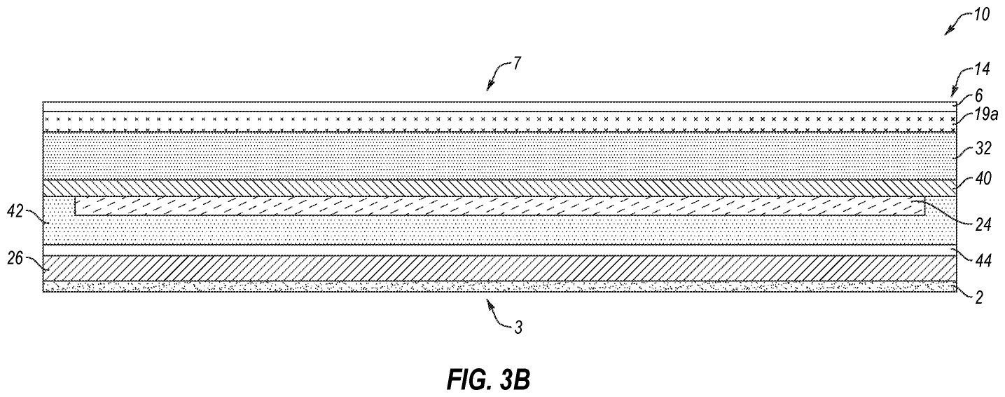

FIG. 3A shows an exploded perspective view of an embodiment of the compute device 10, and FIG. 3B shows a side view of this embodiment of the compute device 10. The layered compute device 10 can have various configurations. For example, some of the components of the compute layer can be separated into their own layers. Some components of the compute layer may be retained as described in the other figures. In some embodiments, an example layered compute device 10 can be configured with the layers as shown in FIGS. 3A-3B. However, at least the solar element layer can be omitted.

A protective coating or film is provided for the protective layer 6, which can be configured with UV reflective materials and/or waterproofing materials. In an example, the protective coating can be one or more layers. Alternatively, the protective coating (e.g., not coating sides of other layers) can be an encapsulation (e.g., coating sides of other layers). The coating or film can be a polymeric material, such as those used in protective applications for electronic devices.

An antenna layer 19a can be provided with a primary antenna member 19b. The primary antenna 19b can be a conductive material (e.g., optically transmissive), which can be used in antenna applications. The antenna material can be a transparent, translucent, or other optically transmissive conductive material in the form of an antenna shape. It is well known that different antenna can have different shapes. A patch antenna assembly can include the primary antenna member 19b as a planar conductive member having a shape tuned for the use of the antenna. The antenna layer 19a may include a single antenna 19b or a plurality of antennas to form wide band array. Also, the antenna layer 19a can include a multiple-in multiple-out (MIMO) configuration. In some aspects, the antenna layer 19a can include a beam-forming array of the antenna members. The primary antenna member 19b can be used to collect signals. Also, the primary antenna member 19b may be configured to be used to capture energy through near field communication or other frequencies.

A transparent insulator can be positioned under the antenna layer 19a to provide for electronic isolation of the primary antenna member 19b from other electronics or electrically conductive components of the layered compute device 10. The transparent insulator can be any electronic insulating material that is transparent, such as polycarbonate, polyurethane, aramid, or others.

A solar element 40, such as a solar panel (PV), can be provided for collection of solar energy to power the layered compute device 10. In some embodiments, the solar element 40 can be used as a ground plane for the primary antenna member 19b. The solar element 40 can be a standard member included in the layers. Alternatively, the solar element 40 can be printed in such a way as to include the antenna element self or multiple antenna elements. The solar element 40 may function as both a solar panel and the antenna.

While not shown in FIGS. 3A-3B, there can be vias between any of the layers with electronic components as in FIG. 1D. The vias can be electrically conductive holes in the material layers or conductive layer, which allows for the vias to communicate power, data or RF through each via to a different layer. The vias can be configured for suitable electricity power and data transmission. For example, the antenna 19b and solar panels of the solar element 40 can be printed around such vias.

A battery 24 can be provided as a layer that is electronically coupled with the solar element 40. The battery 24 can be a standard battery that is adhered in the layer stack. Also, the battery 24 can be printed on a substrate, whether alone or with other compute layer components. The battery 24 can be a lithium ion, zinc based, carbon based, or super capacitor type battery.

While not specifically shown, it should be understood that an insulation layer may be included between any of the layers with electronically conductive materials, such as the battery 24 and any electronics layer. Alternatively, an electrically insulating layer can have a layer of electronic material (e.g., ink) printed or placed thereon, which may be considered to be two separate layers (e.g., insulating layer and conducting layer), or a conducting layer having the conducting material on or in the electrically insulating layer. As such, additional electrically insulating layers may not be needed when already included.

An electronics layer 42 can be provided with the electronic compute components to function as a compute device, such as shown in the other figures. The elements of the compute layer not specifically having its own layer can be included in an electronics layer 42. However, the electronics layer 42 can be configured into a layer for one or more of the compute layer components. The electronics layer 42 can include electronic components that are printed to another layer, such as an insulation layer. In some aspects, the electronics layer 42 can be printed to the rear of layer of the solar element 40, and may optionally include the battery 42 therein. The electronics layer 42 can also be printed to a rear layer of the battery 42 when a separate layer. The electronics layer 42 can be printed into a film, silicon die, or glued. The electronics layer 42 may include electronic components that are printed, etched, deposited, or otherwise formed.

A bottom protective layer 44 may also be used, which in combination with the top protective coating 6 can cover the device 10. The bottom protective layer 44 may be the same or different material from the top protective coating 6. The bottom protective coating layer 44 can be a waterproof coating of a suitable material, such as those used to encapsulate or cover electronic components. The waterproof coating in the bottom protective layer may be functional with the top protective coating as part of a lamination to encapsulate the other elements and layers contained therebetween. The bottom protective layer 44 can also provide a substrate surface for mounting to an object.

The coupling layer 2 can be any type of coupling layer 2 described herein. The coupling layer may be Velcro, adhesive or magnetic, or include flanges for mounting with fasteners (e.g., bolts and nuts, screws, nails, etc.). Also, the coupling layer may be thermally conductive to remove waste heat from the device 10 into the object to which it is attached.

In the embodiment of the layered compute device 10 of FIGS. 3A-3B, the solar panel can be used as part of the antenna assembly. Solar panels (also known as “PV panels”) are used to convert light from the sun, which is composed of particles of energy called “photons”, into electricity that can be used to power electrical loads, such as the electronic components of the device 10. Such solar panels are well known and can be adapted for use to power a compute device 10 or charge a battery 24.

In some embodiments, the solar panel is printed and is conductive. This allows the solar panel to be used as an effective ground plane for the antenna assembly. Due to its size, laminating the solar panel in conjunction with a transparent insulator and transparent conductive antenna element can create a very high efficiency patch antenna. With this use of the solar panel as the ground plane of the antenna assembly, overall size of the layered compute device is decreased. The sizing also allows for use of larger solar panel elements to be used to compensate for the decreased conductivity of the transparent (or not) primary antenna element. The composition of the printed antenna element may include arrays of small printed solar panel elements to create a MIMO or beam forming array.

Solar panels can include several individual solar cells which are themselves composed of layers of silicon, phosphorous (e.g., provides the negative charge), and boron (e.g., provides the positive charge). Solar panels absorb the photons and in doing so initiate an electric current. The resulting energy generated from photons striking the surface of the solar panel allows electrons to be knocked out of their atomic orbits and released into the electric field generated by the solar cells which then pull these free electrons into a directional current. This entire process is known as the Photovoltaic Effect.

In some embodiments, the ground plane for the antenna assembly can be a part of the battery 24. For example, at least one battery layer of a battery 24 can be used for the ground plane of the primary antenna 19b. The battery 24 can be any standard battery. Also, the battery 24 may be printed and conductive, which allows it to be used as an effective ground plane for the antenna assembly. Due to its size, laminating the battery in conjunction with a transparent insulator, and transparent conductive antenna element can create a very high efficiency patch antenna. With this configuration, overall size is decreased, and larger elements may be used to compensate or the decreased conductivity of the transparent (or not) antenna element. The composition of the printed antenna element may consist of arrays of small, printed battery elements to create a MIMO or beam forming array.

In some embodiments, the device 10 includes both the battery 24 and the solar element 40 as one or more ground planes for the antenna assembly. That is, both the battery 24 and solar element 40 can be configured as ground planes for the antenna assembly, where both can be used at the same time in one antenna configuration, or only the battery 24 can be the ground plane in one antenna configuration or only the solar element 40 can be the ground plane in one antenna configuration. Having both the battery 24 and the solar element 40 as optional ground planes provides for three different antenna assembly configurations.

The layered compute device 10 can have various configurations. For example, some of the components of the compute layer can be separated into their own layers. Some components of the compute layer may be retained as described in the other figures. In some embodiments, an example layered compute device 10 can be configured with the layers as shown in FIGS. 3A-3B without the solar panel elements. The layered compute device 10 may also be configured to run on a battery 42 without any solar elements. That is, the device 10 may be devoid of any solar panels. In this configuration, the battery 42 can provide the power and be used as the ground plane for the primary antenna 19b. In some aspects, the device 10 can omit the battery 24 and run on the solar element 40.

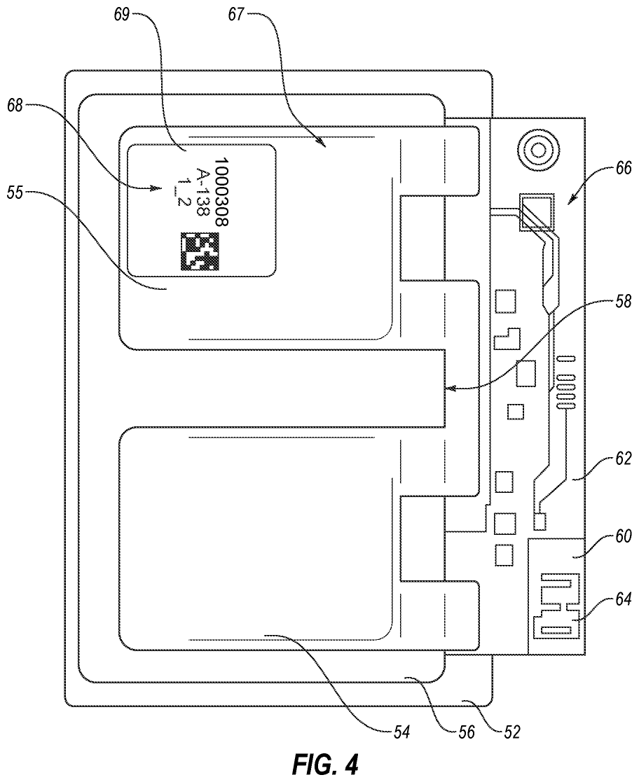

FIG. 4 shows a perspective view of an embodiment of a compute device 50, which can be used in accordance with the descriptions provided herein. The aspects of the compute device 10 provided herein can be applied to the compute device 50, which is relatively planar and flexible. An embodiment of the compute device 50 can include a substrate layer 52 having at least one battery element 54 located thereon, both being flexible, or optionally the battery element 54 being ridged. A protective layer 56 is applied over the at least one battery element 54 with the substrate layer 52 forming an encapsulation that is flexible and bendable. As shown, two battery elements 54 are shown, which are in series via a connector 58. However, one of the batteries could be a solar element 55 having at least one solar panel (and the connector 58 can be configured to accommodate for the solar element 55). An electronics substrate 60 is provided, which can be optionally coated with an insulator layer 62, which can be flexible. The insulator layer 62 can be only a partial covering if desired. The electronics 66 can be on the electronics substrate 60 or on the insulator layer 62, which can be configured to be flexible, such as described herein. The electronics 66 can include the processor, memory, transceiver, and other components for operation of the compute device. An antenna element 64 can be included and electronically coupled with the ground plane of the battery 54 and/or the ground plane of the solar element 55. The ground plane of the battery 54 or solar element 55 can function as the ground plane for the antenna assembly having the antenna element 64. As shown, the antenna element 64 has a shape, which is tuned for use. The tuning of the antenna element 64 shape can be cooperative with the ground plane. While not shown, a protective top layer and/or protective bottom layer, such as the substrate layer 52 and protective layer 65, over the electronics 66, antenna 64, and optionally the electronics substrate 66.

In some embodiments, the electronics substrate 60 can include a printed circuit board (PCB), or it may be an insulating layer having electronics positioned thereon. The electronics substrate 60 can be a heart board, which is flexible or rigid.

In some embodiments, the ground plane for the antenna assembly can be included on the electronics substrate 60, such as a layer underneath the body.

Accordingly, the compute device 50 can be configured as a planar compute device that has different layers of the plane. The planar compute device can include the substrate layer 52 having the battery 54 and solar panel 55 being their own layers over the substrate layer 52. Both the battery 54 and the solar panel 55 are in a planar configuration with planar electrical connections to the bridge connector 58. The electronics substrate 60 is shown to be planar too; however, the electronics substrate 60 may bend at the intersection with the substrate layer 52. This can allow the electronics substrate 60 to bend relative to the battery 54 and solar panel 55 of the flexible substrate layer 52.

FIG. 4 also shows that the compute device 50 can include an external surface 67 having indicia 68 printed thereon. The indicia 68 can be any alphanumeric character, symbol, code, image, design, or combination thereof. As shown, the indicia 68 includes the QR code and an identification number. The indicia 68 allows for a monitoring system (not shown) to record the location of each specific device 50 that is included in a network of such devices. The compute device 50 may be programmed with the data of the indicia 68. The compute device may be attached as a label 69 and have the identifying markings of the indicia 68 printed on top. The identifying marks may include any marking, such as an iCing Code or a QR code. The indicia 68 may also include a unique identifier that may also be stored in a memory of the compute device 50. The unique identifier may be used to track and manage the compute device 50.

The compute device 50 may be attached as a label and have identifying markings printed on top (indicia 58). The compute device may be any shape and size. For example, as illustrated, the compute device is rectangular, although the compute device may have at least one curved edge, have uniform or non-uniform thickness, or any other combination of shape, size, thickness, or the like.

In some embodiments, the compute device the electronics substrate is a flexible PCB substrate. The battery may be attached by rivets to the flexible PCB substrate. However, the flexible PCB substrate can be made of a size sufficient to retain the battery. Accordingly, the layer 52 may be the same layer as 60, which extends under the battery 54 and/or solar panel 55. As such, the battery and electronics can be printed onto the same layer.

In some embodiments, one of layer 60 or 62 is formed of a metal so as to form a ground plane for the antenna assembly with the antenna element 64. Appropriate insulation layers can be used to separate electrically conductive members. The antenna element 64 can be tuned with the ground plane, whether battery and/or solar panel and/or layer 60 or 62. The tuning can be RF tuning or other tuning. Also, different components of the PCB could be used as the ground plane for the antenna assembly.

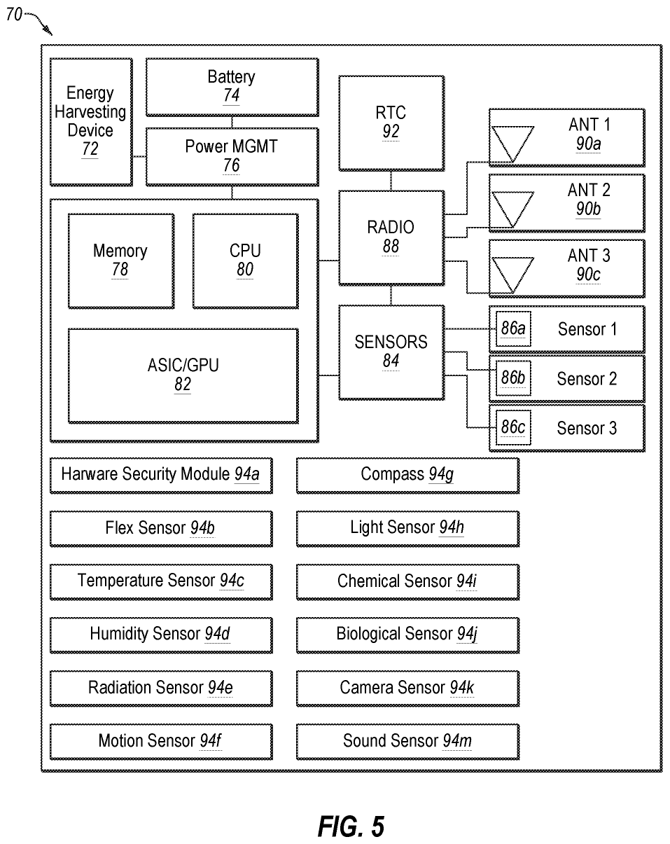

FIG. 5 shows an embodiment of the architecture of an embodiment of a compute device 70. As shown, the compute device 70 includes an energy harvesting device 72 (e.g., solar panel element); battery 74; power management component 76; memory device 78; central processing unit (CPU) 80; ASIC and/or graphics processing unit (GPU) 82; a sensor controller 84; one or more sensor (e.g., sensor 86a, sensor 86b, sensor 86c); a radio module 88 (e.g., a transceiver with a wireless receiver and wireless transmitter); one or more antenna assemblies (e.g., antenna 90a, antenna 90b, and antenna 90c); and a real-time clock (RTC) 92.

The compute device 70 can be configured with a CPU 80, such as system on a chip, neural network chip, ASIC, microprocessor or other computing configuration running a full or real-time operating system (for example FreeRTOS). The memory device 78 can be any type of computing storage, such as Flash or RAM.

The compute device 70 can also include hardware security modules 94a, which can include hardware and memory having security modules. A hardware security module can be a physical computing component that safeguards and manages digital keys, performs encryption and decryption functions for digital signatures, strong authentication and other cryptographic functions. A hardware security module contains one or more secure crypto processor chips.

The power management component 76 can be any power management device that manages power, such as a solar charge controller, battery charge controller, or the like.

The compute device 70 may include a real-time clock (RTC) 92, synchronized by satellite (GPS, GLONASS, GALILEO, BeiDou or others) or internet network time (NTP).

A flex sensor 94b for calculating amount of flex of the compute device 70. The flex sensor 94b can be used or aggregated with onboard sensors to track flex, such as from a flat or curved orientation, such as from the surface to which the device is coupled.

The compute device 70 can also include a temperature sensor 94c, such as a thermo couple or the like. The temperature sensor 94c can provide temperature data for analysis of operating conditions. For example, once the temperature passes an upper or lower temperature threshold, the device can turn off most function or go dormant. Also, compute device operation can be performed when within a temperature range. The temperature sensor 94c can also be used in a weather condition monitoring configuration of the compute device 70.

The compute device 70 can also include a humidity sensor 94d, such as a device that detects and measures water vapor. The humidity sensor 94d can provide humidity data for analysis of operating conditions. The humidity sensor 94d can also be used in a weather condition monitoring configuration of the compute device 70.

The compute device 70 can also include a radiation sensor 94e, such as a device that detects and measures any type of radiation. The radiation sensor 94e can provide radiation data for analysis of operating conditions. The radiation sensor 94e can also be used in a weather condition monitoring configuration or nuclear radiation level detector configuration of the compute device 70. The radiation sensor 943 can include a radiation detector for measuring nuclear, electromagnetic or light radiation.

The compute device 70 can also include a motion sensor 94f, such as a device that detects and measures movement in any direction. The motion sensor 94f can provide motion data for analysis of operating conditions, such as in any degree of freedom. The motion sensor 94f can also be used to be mounted to any type of object, whether stationary (e.g., tree, building) or mobile (e.g., vehicle, train, boat, airplane, scooter, bicycle, etc.). This allows for tracking movement in the compute device 70. The motion sensor 94f can include a gyroscope or accelerometer, as well as a GPS for tracking motion. However, a standalone GPS may be included in addition to a gyroscope or accelerometer. A compass 94g may also be include, which can also provide data for orientation of the compute device 70 and movement thereof.

The compute device 70 can also include a light sensor 94h, which can be any type of light sensor. The light sensor 94h can be used to determine when there is light on the compute device. The light sensor 94h may also be used to receive light data, such as from a laser or other light emitter. The light sensor 94h can then be used to receive data from another device that is transmitted on an optical beam.

The compute device 70 can also include a chemical sensor 94i, which can be any type of chemical, whether natural or synthetic, or beneficial or harmful. The chemical sensor 94i can be configured to detect chemicals in form of gas or liquid. The chemical sensor 94i can be used to determine what type of chemical environment is being exposed to the compute device. The chemical sensor 94i may be for any type of chemical, which is usually not a biological molecule or substance.

The compute device 70 can also include a biological sensor 94j, which can be any type of biological agent, whether natural or synthetic, or beneficial (e.g., therapeutic protein) or harmful (e.g., toxic protein). The biological sensor 94j can be configured to detect biological agents in form of gas or otherwise airborne, or when in a liquid. The biological sensor 94j can be used to determine what type of biological substance is being exposed to the compute device. The biological sensor 94j may be for any type of biological substance, whether natural or unnatural. The biological sensor 94j may be a nucleic acid sensor, such as a chip-based DNA sensor. The biological sensor 94j may also be a peptide or protein sensor, which can include an antibody or ligand for a target receptor. Examples include medical test kit configurations of the invention.

The compute device 70 can also include a camera sensor 94k. For example, the camera sensor may be a CCD or a CMOS, or other. The camera sensor 94k can record still images and video feeds. Accordingly, images can be used to monitor the environment. These images can be transmitted through the network to another device.

The compute device 70 can also include a sound sensor 94m, such as a microphone. The microphone can be used to record sounds around the compute device 70. Accordingly, the sound recordings can be used to monitor the environment, and may or may not be transmitted as part of a video feed.

The device may include an LED indicator on the front to show status or transmit data. The device may also include third party antenna arrays (for example trace or ceramic antennas). Additionally, the device may include interface ports such a USB-C, radio frequency, coaxial, or power, fiber optics

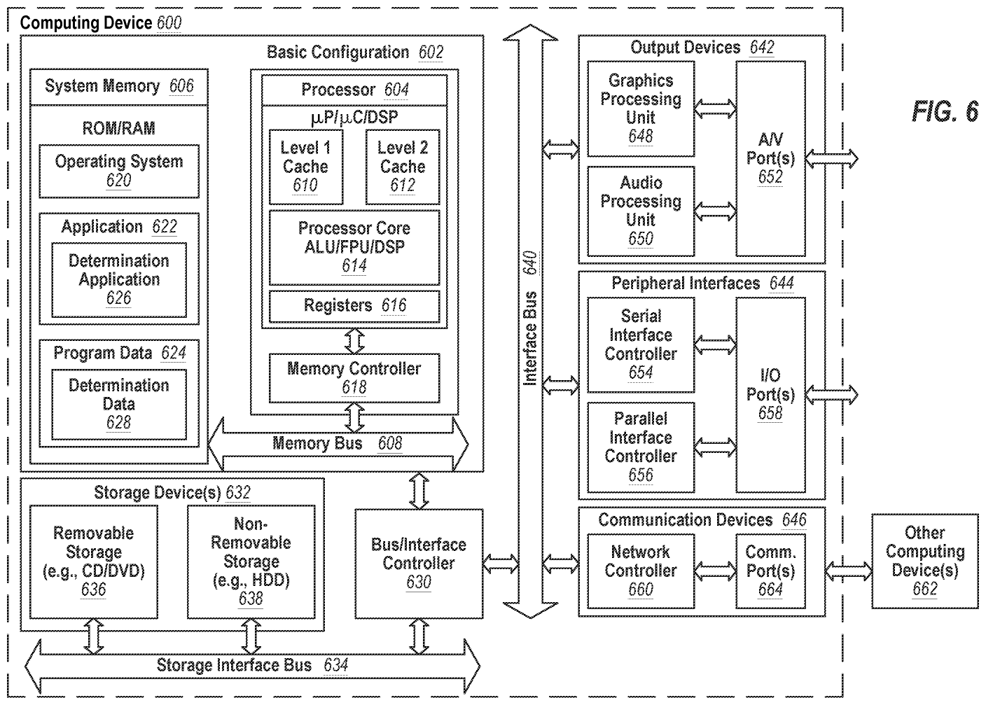

FIG. 6 shows an expanded embodiment of the compute device configured as a computing device 600.

The compute device embodiments described herein can be provided in any shape. The size can be configured to be as small as possible. For example, as illustrated, the compute device is rectangular, although the compute device may have at least one curved edge, have uniform or non-uniform thickness, or any other combination of shape, size, thickness, or the like.

In some embodiments, the compute devices described herein can be configured to operate as computing devices, such as edge compute devices. In some embodiments, the compute devices are the target of computation to be off-loaded from a main CPU. Command-queues can be created in applications and are tied to a specific compute device. Internally, a compute device is a collection of compute units. Compute devices can correspond to a GPU, a multi-core CPU, or multi-core DSP. A compute device can contain one or more compute units. For multi-core devices, a compute unit often corresponds to one of the cores. A work-group executes on a single compute unit and multiple work-groups can execute concurrently on multiple compute units within a device or across a network of interconnected devices (e.g., mesh). A compute unit can have local memory that is accessible only by the compute unit. The compute unit can include a transceiver to transmit data and to receive data, which allows for communication with a network or with other devices through a network.

In some embodiments, the compute device may operate as an edge server to process applications, run neural networks, and store information. Edge computing is a distributed computing framework that brings enterprise applications closer to data sources, such as internet of things (IoT) devices or local edge servers. This proximity to data at its source can deliver strong business benefits, including faster insights, improved response times and better bandwidth availability.

The edge server configuration of the compute device can be a node in a network that is configured to perform computation operations (e.g., compute), networking, storage, and security functions for the network or for a device in the network. The compute device can be proximally close to where users need them. Edge computing is a topology- and location-sensitive form of distributed computing, the term refers to an architecture rather than a specific technology. Edge computing can include all computing outside the cloud happening at the edge of the network, and in applications where real-time processing of data is required. Cloud computing operates on big data while edge computing operates on “instant data” that is real-time data, often generated by sensors or users or incoming data from another device.

In some embodiments, the compute device may operate as a base station. The base station configuration can be configured to connect to other similar devices nearby in a mesh network, which collectively may function as a wireless backhaul. The base station configuration can be configured to connect to other compute devices or other types of devices on a network. The base station configuration can provide wireless service to nearby people and devices, which can include operations as a massive multiple-input and multiple-output (MIMO) array. The base station configuration can connect to ground-based or terrestrial satellites or other networks, and thereby has the hardware and software for such communication functions. The base station configuration can also broadcast telemetry, identifying information of itself or of any other device to another device on the network, a specific device, or to any device that can receive the signal. The base station can also be configured with modules to run software applications, such as for example to collect information, process information, and transmit information outputs.

The use of the compute device in a network or in a distributed system through a network can provide for improvement of computing power or communication power. The compute device can be used to overcome problems in conventional networking by providing a new decentralized network including one or more of the compute devices. In some aspects, a decentralized network may connect numerous devices (e.g., one or more compute devices) using low-power while providing higher connectivity and/or bandwidth. An embodiment includes a crowd-source based method for sending data from a first compute device to a server (e.g., optionally a second compute device) that does not rely on a fixed infrastructure. Another embodiment includes a crowd-source method for a cloud server to send data to a second compute device that does not rely on a fixed infrastructure. A further embodiment includes a method for routing data in beacons from multiple services on multiple compute devices to the appropriate device manufacturer servers. Yet another embodiment includes a method to reduce energy consumption on mobile devices used to collect or exchange data with remote compute devices in a network.

The compute device of the present disclosure may be useful to virtually every field that uses network-based communications. Example parties that may benefit from this disclosure include, but are not limited to, smartphone manufacturers, bike sharing companies, outdoor advertisers, pallet shipping companies, container shipping companies, package shipping companies, telemetry-based asset management companies, environmental monitoring companies, and the like. Example applications may include use for pollution tracking (e.g., environmental data), asset tracking (e.g., shipping pallets, shipping containers, individual packages), status of asset (e.g., functionality, errors, calibrations, or the like) finding lost devices, industrial predictive maintenance, backhaul data network device, wireless base station, hosting station with a hosting service in local or decentralized infrastructure, data routing and others. Further, aspects of the present disclosure may not rely on connectivity using SIM or LPWAN modems, which enables devices to be smaller and more efficient.

For example, in location tracking of devices and assets scenarios, most low cost tracking device makers do not have sufficient app density to provide global coverage. Adding a cellular module and a GPS module is expensive and power hungry. Aspects of the present disclosure may provide a solution that does not require endpoint devices to include cellular or GPS modules which interoperates globally, and lower costs. Now, the compute devices can be configured for use in location tracking of an asset by being applied thereto, such as via adhesive or other mounting. The compute device can then be used for providing location tracking of the asset, such as a vehicle, case of valuables, artwork, data management devices, or the like.

In an example of low power sensor connectivity, the cost of some sensors is so low that adding cellular or GPS connectivity can be an order of magnitude more expensive than the cost of the sensor. Aspects of the present disclosure may provide a connectivity service at a radically lower cost by using the compute device described herein.

Moreover, delay tolerant use cases, such as location updates and environmental/health data, may also benefit from the present disclosure. For example, many use cases do not require immediate cloud or Internet connectivity. In this context, the present disclosure leverages smartphones' Bluetooth connectivity, and their Wi-Fi offloading capabilities to offer a significantly enhanced bandwidth compared to LPWANs. The compute device can be configured to retain the data in memory, and when a passing network device is within range the compute device can then transmit the data for further transmission through the network from the passing network device. In some cases, the compute devices being on moving objects can provide a distributed network with the compute devices being in movement relative to each other and the distributed network in general.

In some embodiments, the compute device can be configured as a fully operational computing device, which includes memory with an operating system, and which can be operated with a battery and/or solar power. The antenna assembly can be configured for any type of signal collection or capture, such as radio frequency identification (RFID) or Bluetooth, etc.

Manufacturing

In some embodiments, the compute device can be manufactured in various ways as described herein. In some aspects, the manufacturing can include printing onto substrates to form the components. In other aspects, manufacturing can include obtaining the components and applying them to the substrates.

In some embodiments, a substrate can be provide, whether flexible or rigid. For example, a paper or polymer material can be provided as a flexible substrate, and then the electronics (e.g., electrically conductive circuit traces) can be printed on the substrate. In some aspects, the circuit traces can provide a ground plane for the antenna assembly. Also, the printing of the electronically conductive material can form a part or all of the battery, such as the cathode or anode, and the other can be on a different layer. This allows the printing of the electronic circuit traces and battery directly onto the substrate.

In some aspects, the solar panel element can be applied to the substrate so as to be operably coupled with a circuit trace. The solar panel element can be obtained as a component and then adhered to the substrate to electronically coupled with the traces and components. Additionally or alternatively, some or all of the solar panel element may be printed as solar panels or solar panel layers. The solar panel element can be on the same layer as the battery or it can be on a different layer and connected by vias during the manufacturing process.

The manufacturing can continue by applying an insulating layer on the printed circuit and components. Then, printing can be performed for creating the next layer of components. Also, some prefabricated components can be adhered to the layer to be electronically coupled with the circuit traces an vias to components on other levels.

Across one or more layers (e.g., a base substrate and then layer substrates), the components described herein can be fabricated by printing and/or component adherence to the layer material. The components can include at least the CPU, memory, transceiver (e.g., radio, wireless), and a power source, such as the battery or solar panel.

In some embodiments, a solar panel can be provided, and an optically transmissive (e.g., clear) insulator (e.g., polymeric material that is electrically insulating) can be coated, deposited, printed or otherwise applied onto the solar panel. Then on top of this insulating layer, another conductive element is provided, such as being printed or preformed and adhered. In some aspects, the conductive element is an antenna member, such as the primary antenna member of a patch antenna assembly. The antenna can be transparent conductor material, which can be a clear antenna element. In some aspects, the antenna elements can be printed over the solar panel. The antenna can be used for beam forming, RF function, or the like. Here, the solar panel is used as the ground pane for the antenna, and the clear antenna allows the solar panel to operate.

In some embodiments, a battery element (e.g., anode and/or cathode) can be provided whether performed or printed on a flexible substrate, and an optically transmissive (e.g., clear) insulator (e.g., polymeric material that is electrically insulating) can be coated, deposited, printed or otherwise applied onto the battery. Then on top of this insulating layer, another conductive element is provided, such as being printed or preformed and adhered. In some aspects, the conductive element is an antenna member, such as the primary antenna member of a patch antenna assembly. The antenna can be transparent conductor material, which can be a clear antenna element. In some aspects, the antenna elements can be printed over the battery element. The antenna can be used for beam forming, RF function, or the like. Here, the battery element is used as the ground pane for the antenna, and the clear antenna allows the solar panel to operate.

In some embodiments, a battery element (e.g., anode and/or cathode) can be provided whether preformed or printed on a flexible substrate, and an optically transmissive (e.g., clear) insulator (e.g., polymeric material that is electrically insulating) can be coated, deposited, printed or otherwise applied onto the battery element. However, it should be recognized that the battery element can be provided so that the conductive parts thereof are electrically insulated, and thereby another layer of electrically insulating material is not required. Then, over the battery element a solar panel can be installed. An optically transmissive (e.g., clear) insulator (e.g., polymeric material that is electrically insulating) can be coated, deposited, printed or otherwise applied onto the solar panel. Then on top of this insulating layer, another conductive element is provided, such as being printed or preformed and adhered. In some aspects, the conductive element is an antenna member, such as the primary antenna member of a patch antenna assembly. The antenna can be transparent conductor material as described herein, which can be a clear antenna element. In some aspects, the antenna elements can be printed over the solar panel. The antenna can be used for beam forming, RF function, or the like. Here, at least one of the battery element or the solar panel is used as the ground pane for the antenna, and the clear antenna allows the solar panel to operate. The solar panel and/or battery element can be dedicated ground planes for the antenna assembly. Alternatively, an antenna configuration controller can control selection of the solar panel, or battery element or both the solar panel and battery element are used as a ground plane for the antenna assembly.

In some embodiments, at least two antenna assemblies can be provided. Accordingly, one antenna assembly can include a first antenna element and the solar panel as the ground plane. Another antenna assembly can include a second antenna element and the battery as the ground plane, where the first antenna element and second antenna element are distinct elements. Optionally, the first antenna element is in a layer over the solar panel and the second antenna element is in a layer over the battery and under the solar panel. However, other configurations may be used.

In some embodiments, the base substrate can be formed with the printed electronics thereon as bottom region. Then, the battery and solar panel layers can be prepared over the base substrate layer. However, it should be recognized that some embodiments include the base substrate with the printed electronics also having a battery element and a solar panel element. Additional layers may also be included with other battery elements so that at least one operational battery is formed. There are various configurations that can be achieved by the manufacturing described herein, whether the components on different layers or on the same layer.

After formation of functional components, a protective coating can be applied to the device to at least the top. However, the protective coating can be applied to the sides and/or to the bottom of the device. The protective coating may be applied to the flexible substrate to receive the bottom surface, or the flexible substrate may be used to receive the bottom surface. The coupling layer (e.g., adhesive, magnetic, etc.) can then be formed to provide the bottom surface that is applied to another object to mount the computing device.

In some embodiments, any number of primary antenna elements or primary antenna element layers can be formed. Each may have a different antenna pattern for a different band or a different use. These different antenna may be independent antenna assemblies, but may also use the solar panel, battery, circuit traces, or other features as the ground plane.

In some embodiments, the flexible substrate is printed with the circuit traces and other electronics and then the battery is applied over the circuit traces so as to be electronically coupled therewith. However, the battery can be provided with an insulating layer, and the circuit traces and electronics can be printed on the battery, whether printing on the top or bottom as per the reference direction in the figures.

In some embodiments, the components of the different layers can be achieved by chemical vapor deposition. The chemical vapor deposition can be performed with masks and etching processes as known in the art. This allows for selectively applying the conductive material onto the flexible substrate.

In some embodiments, the device can include a housing. This can include the compute device being within a housing case, such as being over-molded or glued into the housing. Other configurations and methods of assembly can be provided to protect the compute device.

In some embodiments, the antenna can be manufactured as an RF antenna. RF Antennas are used to receive and transmit electromagnetic waves. These antennas are designed to be used by devices that work at radio frequencies from DC to 18 GHz and RF Families like Bluetooth frequencies, Cellular, General ISM, Navigation, Wi-Fi, and 802.15. The ground plane of the antenna can be prepared to be larger than the wavelength of intended use, which allows for the battery, solar panel, electronic traces, or the like to be the ground plane. Each primary antenna element can be prepared so that it is tuned with the appropriate ground plane. Examples of frequencies for WiFi can include 2.4 GHz, 5 GHz, and 6 GHz, or others. Also, the antenna assembly can be configured for millimeter wave or mmWave, which can high-band 5G, which include frequencies from 25 GHz and beyond (e.g., 60 GHz). Also, the Y band of 325 to 500 GHz can be used. The frequencies of 400 MHz to 800 MHz can also be used. However, any suitable frequency may be used, which may be a standard frequency or any frequency designated for a use at any point. The antenna assembly can be tuned to the desired frequency during manufacturing.

The compute device can be manufactured with a plurality of different antenna assemblies. These can include primary antenna elements on different layers or on the same layer. Each primary antenna element can be tuned to the respective ground plane or combination of ground planes. For example, the manufacturing can electronically couple a first primary antenna element to the battery as the respective ground plane, and an electronically couple a second primary antenna element to the solar panel as the respective ground plane. Multiple antenna assemblies allows for multiple different digital transmission, such as each digital frequency can be used to tune a unique primary antenna element to the appropriate ground plane(s). Accordingly, the compute device can be manufactured to include an antenna assembly controller that controls which antenna assembly is in use or controls the obtained data from each antenna assembly. The antenna assembly controller may be hardware or software configured for implementation of the operations of antenna assembly control. Herein, the radio 88 may be configured as an antenna assembly controller. This allows for multiple input and multiple output antennas.

In some embodiments, the printed circuit board can be prepared to include a ground plane, which can be a copper foil on the board connected to the power supply ground terminal and serves as a return path for current from different components on the board. As such, the PCB ground plane may be used as the antenna assembly ground plane.

Network

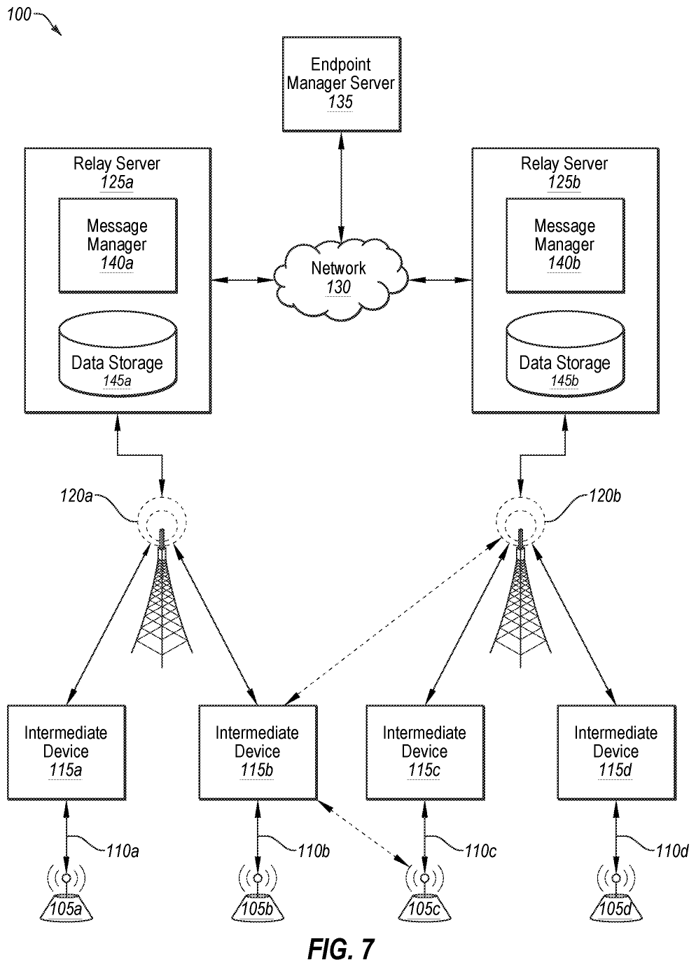

FIG. 7 illustrates an example of network architecture 100 in which embodiments of the compute device of the present disclosure may be implemented. The network architecture 100 may include one or more endpoint devices 105a-d, generally referred to end point device 105, one or more intermediate devices 115a-d (e.g., collectively 115), one or more relay servers 125a-b (e.g., collectively 125), and one or more endpoint manager servers 135. Any of these devices can be a compute device of the present disclosure. In some embodiments, the network architecture 100 may be configured to move data between one or more endpoint devices 105 and various endpoint manager servers 135 by way of crowd-sourced intermediate devices 115. Also, this function may allow the compute device to act as network clients, and one or more relay servers 125. Accordingly, the compute device can function as a network device in the network architecture 100, which can include the network device being configured as any type of network device in the network 120,130 or any network (e.g., mesh, distributed, ad hoc) having the compute device. This can include the compute device supporting any type of network function, such as relays, cell towers, client servers, routers, base stations, and any other type of network device.

An endpoint device 105 may include one or more compute devices or one or more IoT devices. The endpoint device 105 may include a power supply, a data collection device (e.g., a sensor), and a network device and be configured as described herein. The power supply may include a battery, or a connection to a power grid. Additionally or alternatively, the power supply may include an energy harvesting apparatus, such as a solar panel, solar cell, solar photovoltaic, electromagnetic, etc. The endpoint device 105 may also include one or more sensors. The one or more sensors may be configured to detect any type of condition, and generate electronic data based on a detected condition. For example, the endpoint device 105 may include a biological sensor that is configured to generate biological data of the presence of one or more biological substances using. In at least one embodiment, the endpoint device 105 does not have capability to communicate over the Internet and only includes hardware and/or software capable of communicating with nearby devices, such as a nearby intermediate device 115.

The network device of the endpoint device 105 may include any hardware, software, or combination thereof that is capable to communicate with another device via a network. In at least one embodiment, the network device may include any network controller configured to communicate via a short-range network, such as WiFi, Bluetooth® or any other short-range network. In at least one embodiment, the network device may include any network controller configured to communicate via a low-power network. The network architecture 100 may include any number of endpoint devices 105 and the endpoint devices 105 in the network architecture 100 may be any type of endpoint device 105, including any type of network-capable compute device as described herein. The endpoint devices 105 may be fixed or relatively stationary in the network architecture 100, such as when a relay on a building, an intermediate device on a tree, an environmental station or a pollution sensor. Additionally or alternatively, the endpoint devices 105 may be mobile, such as being attached to a vehicle whether having a driver or driverless.

The one or more endpoint devices 105 may be configured to communicate with other devices via at least one wireless network 110a-d. For example, a first endpoint device 105a may be in electronic communication with a first intermediate device 115a via a wireless network 110a. The one or more intermediate devices 115 may include any type of device capable of communicating with an endpoint device 105 via the wireless network 110 and with a relay server 125 via a second network 120a-b (e.g., collectively 120). In at least one embodiment, an intermediate device 115 may include two network controllers—a first network controller to communicate via the wireless network 110 and a second network controller to communicate via the second network 120. Example intermediate devices 115 include compute devices as described herein, or other electronics such as personal computers (PC), laptops, smart phones, netbooks, e-readers, personal digital assistants (PDA), cellular phones, mobile phones, tablets, vehicles, drones, cars, trucks, wearable devices, routers, televisions, or set top boxes, and the like.

As illustrated, the first endpoint device 105a may be in electronic communication with the first intermediate device 115a via the wireless network 110a (e.g., a short-range network). Further, a second endpoint device 105b may be in electronic communication with a second intermediate device 115b via another wireless network 110b (e.g., a low-power network). A third endpoint device 105c may be in electronic communication with a third intermediate device 115c via another wireless network 110c. A fourth endpoint device 105d may be in electronic communication with a fourth intermediate device 115d via another wireless network 110d.

In some embodiments, the wireless network 110 may be any network that uses a relatively low amount of power. Example wireless networks 110 may include any Bluetooth® network type (e.g., Bluetooth Low Energy (BLE), Bluetooth 4.0, Bluetooth 5.0, Bluetooth Long Range), LTE Direct, LTE-M, LTE M2M, Wi-Fi, or any low-power network. The one or more endpoint devices 105 may connect to various intermediate devices 115 using different types of wireless networks 110. For example, the first endpoint device 105a may be in electronic communication with the first intermediate device 115a via a first short-range wireless network 110a and the second endpoint device 105b may be in electronic communication with the second intermediate device 115b via a second short-range wireless network 110b.

Endpoint devices 105, intermediate devices 115, or both, may be relatively stationary or moveable, depending on the type of object the compute device is coupled to. When an endpoint device 105 and an intermediate device 115 come into wireless range of each other, the endpoint device 105 and the intermediate device 115 may perform a handshake and/or authentication to initiate data exchange between the endpoint device 105 and the intermediate device 115.

In some embodiments, the endpoint device 105 may periodically send beacons that include data via the wireless network 110. The endpoint devices 105 may include various services that may run on the endpoint devices 105. Beacons may be generated for each of these services or a single beacon may be generated to include data for some or all of the services. The services are described in more detail herein.

An intermediate device 115 may listen for such beacons from endpoint devices 105. Responsive to receiving a beacon, the intermediate device 115 may send the beacon to a relay server 125 via a second network 120. In at least one embodiment, the wireless network 110 and the second network 120 are different types of networks. For example, the wireless network 110 may be a Bluetooth® network and the second network 120 may be a cellular network, Wi-Fi, or the Internet.

The second network 120 may include a public network (e.g., the Internet), a private network (e.g., a local area network (LAN) or wide area network (WAN)), a wired network (e.g., Ethernet network), a wireless network (e.g., an 802.xx network or a Wi-Fi network), a cellular network (e.g., a Long Term Evolution (LTE) or LTE-Advanced network, 1G, 2G, 3G, 4G, 5G, etc.), distributed network, ad hoc network, and the components thereof, such as routers, hubs, switches, server computers, and/or a combination thereof.

The relay server 125 may send the beacon, or information related to the beacon, to an endpoint manager server 135 via a third network 130. The third network 130 may include a public network (e.g., the Internet), a private network (e.g., a local area network (LAN) or wide area network (WAN)), a wired network (e.g., Ethernet network), a wireless network (e.g., an 802.xx network or a Wi-Fi network), a cellular network (e.g., a Long Term Evolution (LTE) or LTE-Advanced network, 1G, 2G, 3G, 4G, 5G, etc.), distributed network, ad hoc network, or the components thereof, such as routers, hubs, switches, server computers, and/or a combination thereof. In at least one embodiment, the second network 120 and the third network 130 are the same network or include at least some overlapping components.

The one or more relay servers 125 may include one or more compute devices as described herein configured as a relay server, computing devices, such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components. The one or more relay servers 125 may be configured to receive a beacon from an intermediate device 115. The one or more relay servers 125 may send the beacon, or data related to or associated with an endpoint manager server 135. The one or more relay servers 125 may receive a message from the endpoint manager server 135 and, in some embodiments, may send the message from the endpoint manager server 135 to an intermediate device 115. In at least some embodiments, the intermediate device 115 may perform one or more operations responsive to receiving the message from the endpoint manager server 135. The operations include operations local to the intermediate device 115, and/or sending the message from the endpoint manager server 135 to an endpoint device 105.

The endpoint manager server 135 may include one or more compute devices as described herein configured as an endpoint manager server, computing devices, such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components. The endpoint manager server 135 may be associated with one or more endpoint devices 105. For example, a particular corporation, person, or manufacturer may sell an endpoint device 105 and may use an endpoint manager server 135 to communicate with and/or control the endpoint device 105.

The endpoint manager server 135 may send messages associated with a particular endpoint device 105, or a set of endpoint devices 105. For example, the endpoint manager server 135 may send updates (e.g., firmware, software) to the particular endpoint device 105, or the set of endpoint devices 105. The endpoint manager server 135 may send other communications to an endpoint device 105, such as a response to a request from a beacon generated by the particular endpoint device 105.

Each relay server 125 may include a message manager 140. The message manager 140 may be implemented using hardware including a processor, a microprocessor (e.g., to perform or control performance of one or more operations), an FPGA, or an ASIC. In some other instances, the message manager 140 may be implemented using a combination of hardware and software. Implementation in software may include rapid activation and deactivation of one or more transistors or transistor elements such as may be included in hardware of a computing system (e.g., the relay server 135). Additionally, software defined instructions may operate on information within transistor elements. Implementation of software instructions may at least temporarily reconfigure electronic pathways and transform computing hardware.

Each relay server 125 may include a data storage 145. The data storage 145 may include any memory or data storage. In some embodiments, the data storage 145 may include computer-readable storage media for carrying or having computer-executable instructions or data structures stored thereon. The computer-readable storage media may include any available media that may be accessed by a general-purpose or special-purpose computer, such as a processor. For example, the data storage 145 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the data storage 145. In the depicted embodiment, the data storage 145 is part of the relay server 125. In some embodiments, the data storage 145 may be separate from the relay server 125 and may access the data storage 145 via a network. In at least one embodiment, the data storage 145 may include multiple data storages.

The data storage 145 may include data pertaining to the endpoint devices 105, intermediate devices 115, and endpoint manager servers 135 and relationships between the endpoint devices 105, intermediate devices 115, and endpoint manager servers 135. For example, the data storage 145 may include a table or list of endpoint devices that are associated with a particular endpoint manager server 135. The data storage 145 may include data pertaining to beacons received from endpoint devices, such as a timestamp of the receipt of the beacon, a timestamp associated with the creation of the beacon, a geo-location associated with the beacon and/or the endpoint device 105 that created or transmitted the beacon, sensor data associated with the endpoint device, routing information for how and/or where to send data between endpoint manager servers 135 and endpoint devices 105, connection strengths between intermediate devices and endpoint devices, proximity of an endpoint device 105 to an intermediate device 115, type of wireless network 110 that connects an intermediate device 115 and an endpoint device 105, a cost of a connection between an intermediate device 115 and an endpoint device 105, a current battery level of the intermediate device, a type of intermediate device, etc.

The message manager 140 may process communications between the endpoint devices 105, the intermediate devices 115 and the endpoint manager server(s) 135. In an example, the message manager 140 may receive a beacon from the intermediate device 115a via the second network 120a. The beacon may have been sent to the intermediate device via the wireless network 110a by endpoint device 105a. A beacon may contain characteristics about the endpoint device 105, including an identifier of the endpoint device 105 (e.g., a MAC address, a unique ID), a geographical location of the endpoint device 105a, and advertisements of the UUIDs of the services it supports, etc. The message manager 140 may identify the characteristic of the beacon, such as by analyzing the beacon to identify information pertaining to the beacon. The message manager 140 may access the data storage 145 to identify, based on the characteristic of the beacon, an endpoint manager server 135 that is associated with the beacon. For example, the identifier of the endpoint device may be associated with a particular manufacturer that operations a particular endpoint manager server 135. The message manager 140 may identify this particular endpoint manager server 135 in the data storage 145 and an address and/or path to send the beacon in order to reach the endpoint manager server 135. In at least some embodiments, the message manager 140 may send the beacon, or a beacon message to the endpoint manager server 135 via the third network 130. The beacon message may include the beacon, may not include the beacon, or may include information pertaining to the beacon.

In at least one embodiment, a beacon may include data from multiple services associated with the endpoint device 105. Additionally or alternatively, multiple beacons from a single endpoint device 105 may be generated and broadcast via the wireless network 110. Each of these multiple beacons, for example, may be associated with a different service associated with the endpoint device 105. The message manager 140 may identify the services, and based on information for the service, identify an appropriate endpoint manager server 135 that should receive a beacon message.

The endpoint manager server 135 may receive the message from the relay server 125. The endpoint manager server 135 may store the message, process the message, generate a report based on the message, may generate a notification or response based on the message, or any other action. For example, endpoint manager server 135 may generate a response message pertaining to the beacon message. The response message may include a message intended for one or more of the relay server 125, an intermediate device 115, the endpoint device 105 that generated the beacon, or another endpoint device 105 that did not generate the beacon. The endpoint manager server 135 may send the response message to the same relay server 125 that sent the beacon message to the endpoint manager server 135 (e.g., the relay server 125a), or to a different relay server 125 that did not send the beacon message to the endpoint manager server 135 (e.g., relay server 125b).

The relay server 125 may receive, from the endpoint manager server 135, the response message pertaining to the beacon message. The relay server 125 may process the response message, such as by performing operations at the relay server 125, sending data to another device (e.g., a user device), sending data to an endpoint device 105, etc.

The network architecture 100 may be used to exchange data between any devices capable of network-based communication in a manner that is different than conventional communication over the Internet.

In an example, the network architecture 100 may leverage existing smartphone infrastructure to create delay-tolerant connectivity. The network architecture 100 can move data to the cloud in an initially delay tolerant fashion, which may be useful for many types of communications such as firmware updates, status updates, log-file storage, and micropayments. The intermediate device may include software that runs on smartphones to periodically scan for other compute devices (e.g., the endpoint devices 105) described herein. These endpoint devices 105 may connect with the software client running on the smartphones to create massive, area wide networks for moving data to and within the cloud.

Further, it has been estimated that 95% of the human population is covered by some sort of cellular service. The network architecture 100 can be deployed anywhere in the world and enables regions of lower connectivity to increase their connectivity. Moreover, the network architecture 100 can provide coverage beyond the reach of conventional cellular networks by using software that runs on Bluetooth-enabled smartphones, for example. Users may travel to areas of limited or no cellular connectivity, but still may receive beacons from endpoint devices 105 via the wireless network 110. Using the network architecture 100, telco operators, for example, can now easily deploy a software update to their user devices to begin communicating with endpoint devices 105 as described herein to provide higher latency of compute device (e.g., edge compute device) connectivity to even the remotest regions of the world.

In a specific example, the network architecture 100 can be used for asset tracking and management. For example, the network architecture 100 can be used to find lost items that are coupled with a compute device configured as an endpoint device 105, such as a car, bike, drone, or other with an attached compute device configured as a tracking beacon. However, expensive or important items, such as a laptop, briefcase, luggage, or other can include the compute device as an asset tracker. A user, for example, may indicate that the asset item having the compute device configured as an asset tracker is lost, such as by using a mobile application or website to indicate, to the endpoint manager server 135 or to the relay server 125, that the item is lost. In a first embodiment, the endpoint manager server 135 may send a message to one or more relay servers 125 to watch for the lost asset item. The relay servers 125 may add an identifier for the compute device associated with the lost item to a lost item watch list. As intermediate devices 115 move to different geographic locations, they can receive beacons from different endpoint devices 103. The intermediate devices 115 then forward the beacons to the relay servers 125. When a relay server 125 server receivers a beacon, the relay server 125 can analyze the beacon to determine if the beacon originated at an endpoint device 105 that is on the lost asset watch list. When the relay server 125 identifies a beacon that originated at an endpoint device 105 that is on a lost asset on the watch list, the relay server 125 can notify the endpoint manager server 135 that the lost item has been found. In at least some embodiments, the relay server 125 may send the notification that the lost item has been found as a push notification or as a pull notification (i.e., in response to a request from the endpoint manager server 135). In at least some embodiments, the relay server 125 may send the notification that the lost item has been found to the user device that was used by the user to indicate that the item was lost.

Modifications, additions, or omissions may be made to the network architecture 100 without departing from the scope of the present disclosure. The present disclosure more generally applies to the network architecture 100 including one or more endpoint devices 105, one or more wireless networks, one or more intermediate devices 115, one or more second networks 120, one or more relay servers 125, one or more third networks 130, and one or more endpoint manager servers 135 or any combination thereof.

Moreover, the separation of various components in the embodiments described herein is not meant to indicate that the separation occurs in all embodiments. In addition, it may be understood with the benefit of this disclosure that the described components may be integrated together in a single component or separated into multiple components.

The dashed lines from intermediate device 115b to the network 120b and the device 105c show movable network devices in the distributable network or ad hoc network. Now, the intermediate device 115b has moved to a different geographical location. In response to this move, the intermediate device 115b is no longer in communication with the relay server 125a and instead, is in communication with the relay server 125b. The intermediate device 115b is also no longer close enough to the endpoint device 105b to be able to communicate with the endpoint device 105b. As illustrated, there is no intermediate device 115 that is within range of the endpoint device 105b. The endpoint device 105b, however, may continue to send beacons even though there is no device within range to receive the beacons.

Also illustrated, the intermediate device 115b is now within range of the endpoint device 105c. The intermediate device 115b is now able to communicate with the endpoint device 105c via the wireless network 110e, such as by receiving beacons from the endpoint device 105c and by sending response messages to the endpoint device 105c. In at least some embodiments, the intermediate device 115c may have previously received a beacon from the endpoint device 105c and may have forwarded the beacon to the relay server 125b. The relay server 125b may have sent a beacon message to the endpoint manager server 135 and may have received a response message from the endpoint manager server 135. Since the intermediate device 115b is now within range of the endpoint device 105c, as well as the intermediate device 115c, the relay server 125b may select one of the intermediate device 115b or the intermediate device 115c to handle sending the response message to the endpoint device 105c. The relay server 125b may use any selection criteria to select which intermediate device 115 to use to send the response message, such as a connection strength between the intermediate device 115 and the target endpoint device 105, a proximity of an endpoint device 105 to an intermediate device 115, a type of wireless network 110 that connects an intermediate device 115 and an endpoint device 105, a cost of a connection between an intermediate device 115 and an endpoint device 105, a current battery level of the intermediate device, a type of intermediate device, etc.

In at least some embodiments, both of the intermediate device 115b and the intermediate device 115c are within range of the endpoint device 105c and both receive the same beacon from the endpoint device 105c. Further, the intermediate device 115b and the intermediate device 115c both may forward the beacon of the endpoint device 105c to the relay server 125b. To reduce redundancy, network traffic, battery life, etc., the relay server 125b may select one of the intermediate devices 115b and the intermediate device 115c to handle communication with the endpoint device 105c and instruct the non-selected intermediate device to ignore beacons from the endpoint device 105c, to discard beacons from the endpoint device 105c, to stop sending beacons from the endpoint device 105c, or any other operation that may reduce network congestion, free-up data storage space, free-up processor capabilities, etc. As more intermediate devices 115 become available for data transport, data transmission frequency for a particular intermediate device may decrease. In the long term, with enhanced density intermediate device and machine learning based protocols, the technology described here may significantly improve battery life for intermediate devices, reduce network congestion, improve global connectively, etc. The relay server 125b may use any selection criteria to select which intermediate device 105 to use to communicate with the endpoint device 105 and which intermediate device to cease communications regarding the endpoint device 105, such as a connection strength between the intermediate device 115 and the target endpoint device 105, a proximity of an endpoint device 105 to an intermediate device 115, a type of wireless network 110 that connects an intermediate device 115 and an endpoint device 105, a cost of a connection between an intermediate device 115 and an endpoint device 105, a current battery level of the intermediate device, a type of intermediate device, etc.

In some embodiments, the compute device 10 can be configured to operate as a mobile phone or a node of the network, such as being the endpoint device 105. However, software and hardware modifications can result in the compute device being the intermediate device. Accordingly, application can be with IoT devices with the IoT devices being the endpoint devices 105 with the compute device 10 described herein being the intermediate device.

In some embodiments, the compute device 10 can be configured to operate as a component in a network, such as a base station, relay, or the like, which can be part of the network 120. Such operation can be obtained with the software and hardware modifications to be the network component.

Additionally, software and hardware modifications can result in the compute device 10 being the relay server 125 with a controller being the message manager 140b. This allows the compute device 10 to receive transmissions from an intermediate device, such as a cell phone, and operate as the relay server. Furthermore, software and hardware modifications can result in the compute device 10 being the endpoint manager server 135. Accordingly, a network may include a plurality of endpoint manager servers 135 via a plurality of compute devices in a distributed computing system network.

The intermediate device 115 can use data received from the endpoint device 105 for one or more computations that are executed by a processor of the intermediate device 115. The one or more computations may include any type of computation, including computations related to artificial intelligence, deep learning, machine learning, etc. The one or more computations executed by the processor of the intermediate device 115 can result in an output. The intermediate device 115 can then send the output to any other device, such as back to the endpoint device 105, to a relay server 125, to another intermediate device 115, or to any other device.

In some embodiments, the compute devices can be configured as servers by including server components. This allows the server compute device to be applied to objects in a region to obtain a mesh network, where each server compute device communicates with at least the other server compute device that is within communication range (e.g., 125a to 125b). Also, intermediate compute devices can be part of the mesh network. This also allows for each compute device in the mesh network to communicate with a plurality of other compute devices within communication range. For example, gigabits of data or more may be passed between the compute devices in the mesh network. Different compute devices can have different roles in the mesh network, which can depend on the programing and hardware as well as the location and relative position to other nodes in the mesh network. In some instances, a first compute device may have a specific role in the mesh network, such as an endpoint device or an intermediate device. However, due to the ability of the compute devices to be movable, the first compute device may need to switch to being a relay server for the mesh network to operate efficiently, and thereby the mesh network can convert the first compute device into a relay server. The first compute device may already have the hardware and software to function as a relay server, or the mesh network can push software to the first compute device to change to the relay server. As such, compute devices can flip flop through different roles in the mesh network, which can be useful for optimizing communication through the mesh network. Thus, a mesh network can be obtained with a plurality of the compute devices described herein.

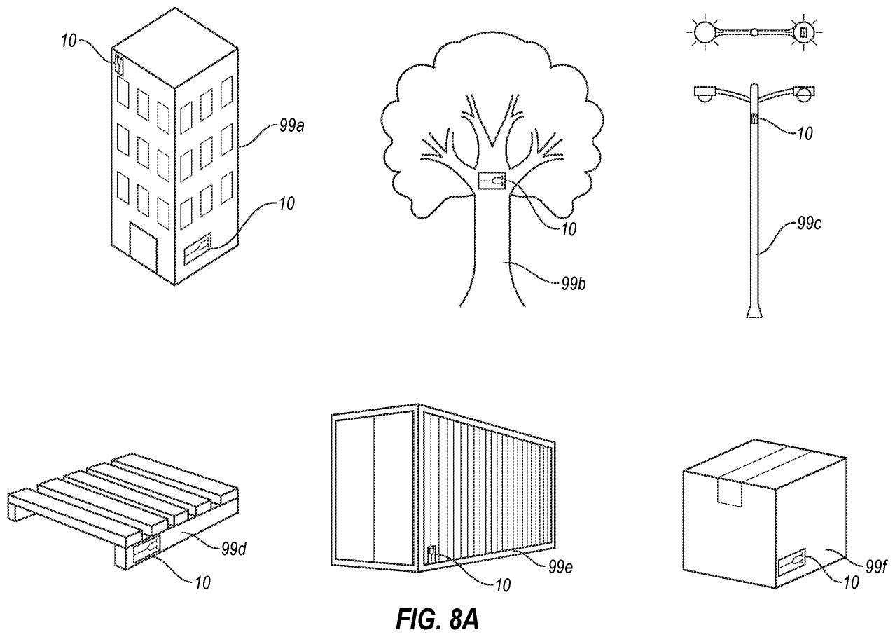

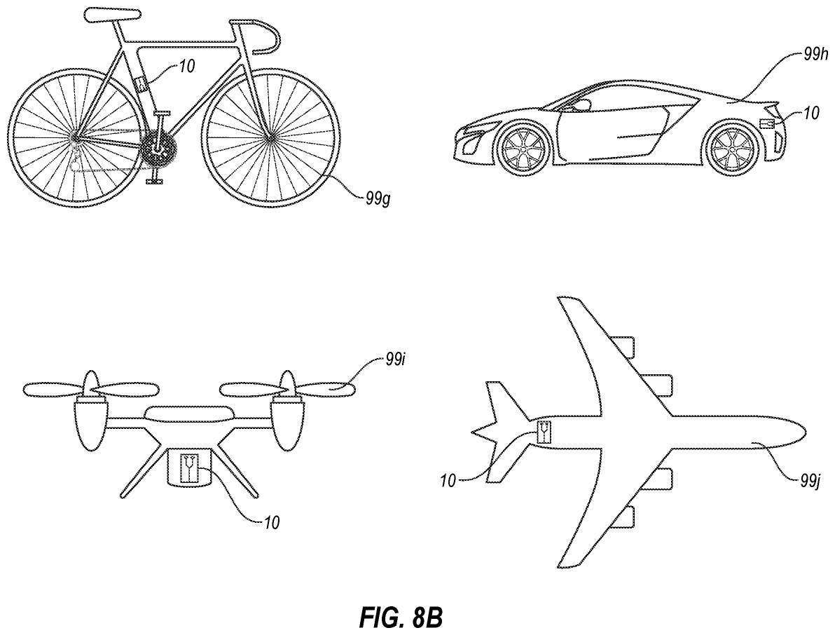

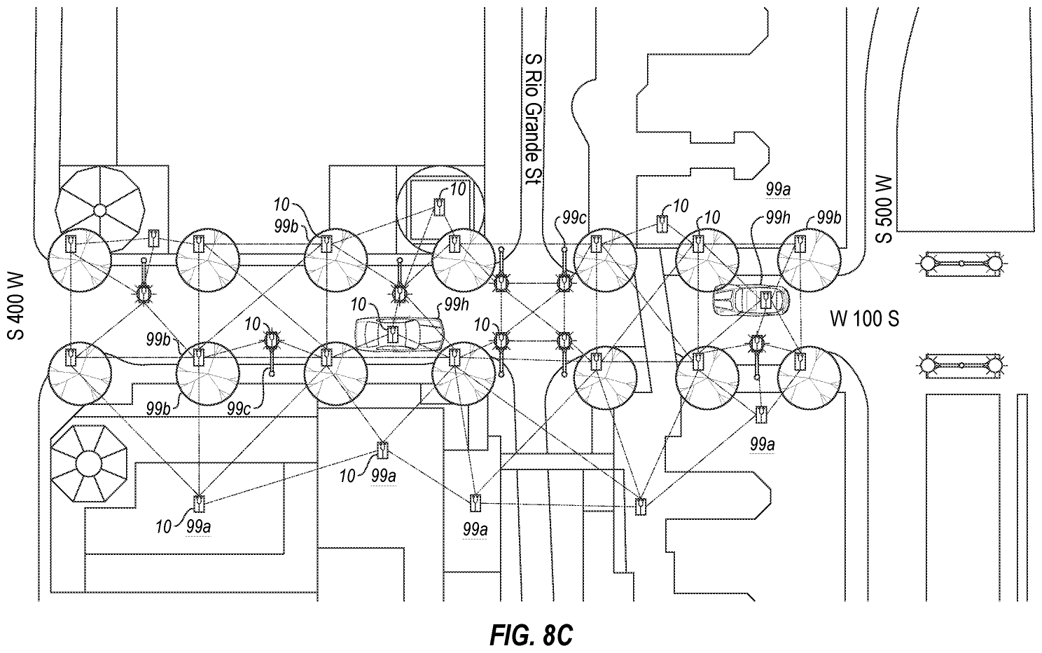

FIGS. 8A-8B show examples of some objects having the compute device 10 of the present invention. As shown, a building 99a, tree 99b, utility pole 99c, pallet 99d, shipping container 99e, package 99f, bicycle 99g, vehicle 99h, drone 99i, and plane 99j can include the compute device 10, however, any other building with a flat or curved surface can receive the compute device 10 mounted thereon (e.g., adhesive).

The compute device 10 can be configured as a shipping asset tracking device. Accordingly, the compute device can be attached to shipping assets that are transportable, such as pallets 99d, shipping containers 99e, or individual packages 99f. The compute device 10 can include a GPS and operate as described herein and provide location information to an endpoint device 105 or function as the endpoint device 105 and provide the data to the intermediate device 115. The shipping asset can then be tracked with the shipping asset tracking device in accordance with the description herein of asset tracking.

FIG. 8C shows examples of an environment having a network formed by a plurality of the compute devices 10. As shown, a plurality of objects, such as buildings 99a, trees, 99b, utility poles, 99c, and vehicles 99h form a mesh network, as shown by the dashed lines. The dashed lines show the line of communication between the communicating compute devices 10. Accordingly, the compute device 10 communicates in a mesh network with the other compute devices 10 that are in range, as shown by the dashed arrows. Of course, the representation may be only a partial network and the rest of the network can extend as shown in FIG. 8C.

The compute device 10 can be configured as a telemetry broadcaster. Accordingly, the compute device 10 can perform in situ collection of measurements or other data at remote points and then facilitate automatic transmission to receiving equipment (e.g., 105, 110, etc., telecommunication) for monitoring (e.g., endpoint manager server 135). The telemetry broadcaster configuration can take advantage of the low cost and ubiquity of available networks, such as GSM networks by using SMS to receive and transmit telemetry data; however, other network or data transmission networks can be used (e.g., distributed or ad hoc networks with the compute devices). The compute device can be configured as a telemeter acquisition device used in telemetry. The common fields of telemetry can include oil and gas industry (e.g., drilling mechanics), motor racing (e.g., car data, engine operation, acceleration, temperature, wheel speed, suspension displacement, etc.), transportation (e.g., information about vehicle operation or driver performance), agriculture (e.g., weather, soil moisture, air temperature, relative humidity, precipitation, microbe presence, pathogen presence, chemical presence, etc.), water management (e.g., automatic meter reading, groundwater monitoring, leak detection, etc.), missile operations, remote-piloted vehicles (e.g., over land, water, or air), spacecraft, oil rigs, chemical plants, satellites, space science, rocketry, flight testing, military intelligence, energy monitoring (e.g., HVAC system, electricity, gas, etc.), resource distribution (e.g., logistics to channel resources), heath status of subject (e.g., healthcare patient monitoring and management), wildlife management (e.g., animals outfitted with compute device with sensors measuring temperature, diving depth and duration, speed of travel, locations), retail (e.g., product packaging having compute device with tracker, such as RFID, GPS, etc.), law enforcement (e.g., criminal tracking, vehicle tracking, etc.), hostile environment testing (e.g., munitions storage facilities, radioactive sites, volcanoes, deep sea, and outer space), hardware operation monitoring and software operation monitoring. Accordingly, from these examples it should be expected that other telemetry acquisition and broadcasting telemetry data functions can be performed with the compute device.

In some aspects, the telemetry can provide status of an asset. For example, the status can be of operation of an augmented reality (AR) device, such as in WO 2021/062293, which is incorporated herein by specific reference. The compute device can function as the sensor or sensor data transmitter. For example, the compute device can be attached to a specific object, and then object has its own identity to a virtual reality or augmented reality, such as the Metaverse.

In some aspects, the telemetry can provide environmental information of a location to outside of the location. One or more of the compute devices can be used to form a network or join a network, such as distributed or ad hoc, to communicate environmental from a test site to a monitoring site. This allows a human monitor to be remote from the potentially hazardous environment being studied.

In some embodiments, the compute device can be configured to be used as a device in a backhaul data network. Accordingly, the compute device can be configured to backhaul (or communicate amongst each-other) using a specific radio channel. In a hierarchical telecommunications network, the backhaul portion of the network comprises the intermediate links between the core network, or backbone network, and the small subnetworks at the edge of the network. The backhaul compute device can be in the side of the network that communicates with the global Internet or at an Internet exchange point or other core network access location. Cell phones communicating with a single cell tower constitute a local subnetwork; the connection between the cell tower and the rest of the world begins with a backhaul link to the core of the internet service provider's network (via a point of presence). A backhaul compute device may include wireless components. Wireless sections may include using microwave bands and mesh and edge network topologies that may use a high-capacity wireless channel to get packets to the microwave or fiber links.

In some embodiments, the compute device can be configured for operation as a wireless base station, such as for connecting people and devices. When configured as a computer network base station, the compute device functions as a transceiver acting as a switch for computers in the network, such as connecting them to another local area network and/or the Internet. In the area of wireless computer networking, a base station compute device can be configured with a radio receiver/transmitter that serves as the hub of the local wireless network, and may also be the gateway between a wired network and the wireless network. It typically includes a low-power transmitter and wireless router.

Also, the compute device can be configured as a router for routing data through the wireless network. This can include selecting receiving devices to transmit the data so that the data arrives eventually at the desired destination for the data.

In some embodiments, the compute device can be configured to be used as a hosting service for a local network infrastructure or a decentralized network infrastructure, which can be a distributed network or ad hoc network. The hosting service can host the operation of the infrastructure.

In some embodiments, the compute device can be configured to be used for hosting application, such as hosting a block chain node or hosting a virtual machine. Blockchain-based web hosting, also known as decentralized web hosting, which can be via the network. The hosting application for blockchain offers peer-to-peer services rather than client-to-server hosting. The compute device can be a blockchain node and part of the block chain system.

The compute device can be configured as a virtual machine to receive calculations from a master machine for performance, and transmitting the results back to the master machine. The compute device can receive offloaded computations from any master machine in the network to compute the computations and provide the results back to the source or to a specified compute device destination. This can allow for the compute device to include an application that can perform the processing of a specific node or any node of a network. For example, the compute device can operate as a virtual machine and perform data analytics, and then process the data analytics for transmission to the network or a cloud network. Accordingly, the compute device can be tailored for particular operations by applications installed thereon, which allows for performance of the virtual machine functions.

In some embodiments, the compute device can be configured as a software defined radio (SDR). The software defined radio configuration of the compute device allows users to tune into a variety of frequencies and decode data. SDR technology is that it can be programmed to suit the user's exact specifications; minor software adjustments can make the radio match the requirements. SDR is a form of radio in which some or all of the functions at the physical layer are defined by software. In other words, the program is used to evaluate the radio's specifications and capabilities. If the radio's software is updated, the radio's output and functionality can be affected. SDR has a common hardware architecture on which software runs to include functions, such as modulation and demodulation, filtering (which includes bandwidth changes), and other functions such as frequency selection and, if necessary, frequency hopping. The output of the radio is altered by reconfiguring or modifying the program. To accomplish this, software modules running on CPU of the compute device can be used to execute radio functions such as transmitting and receiving signals.

In some embodiments, the compute device can be configured to operate as a self compute device in a network of such compute devices to determination of information about the self compute device and the other compute devices. For example, a group of such compute devices can use communication data between the network devices, such as a combination of time of flight, signal strength, phase shift, angle of arrival to determine relative positions of the self compute device and other compute devices. As such, even without GPS, a group of the compute devices can use the communication data to make an accurate determination of the position and relative position of each compute device in the network or without a defined network region of connected compute devices.

In some embodiments, the compute device can be configured to be self aware and to detect a presence of other nearby compute devices. The compute device can establish a connection between any or all nearby compute devices. The connection may be any type of connection, such as hub and spoke, distributed, decentralized, mesh, relay, etc.

In some embodiments, the compute device is configured to be wearable, such as by the coupling member being configured to be attached to skin of a subject (e.g., animal, such as human, dog, horse, cat, etc.) or mounted to a clothing or harness on the subject. The compute device can have one or more sensors monitoring various health parameters. The health parameters can include fitness tracking, electrocardiogram (ECG), blood pressure, biosensors, body temperature, blood oxygen saturation, posture, physical activity, ballistocardiogram (BCG), presence of pathogen, presence of disease biomarker, pregnancy, biometrics, health status, and wellbeing of a subject. In some aspects, the adhesive is a medially approved adhesive for attachment to skin, such as in known skin adhering medical devices. The device may be integrated into a wearable device or be a separate device for medical testing kit. The health data can be cryptographically verifiable, as can any of the data transited into or from the compute device.

In an example, the device can include a gene sequencing apparatus, which can be configured to be disposable. Sequencing employs a technique known as electrophoresis to separate pieces of DNA that differ in length by only one base. Smaller molecules move through the gel more rapidly, so the DNA molecules become separated into different bands according to their size. The compute device can include the components of a gene sequencer or can receive wireless data from a gene sequencer, such as for providing the data to a healthcare network.

In some embodiments, the compute device can function as a programmable compute device. The compute device can receive program data (e.g., software) for programming the compute device. This program data can be executed to implement a new functionality to the compute device, such that the program data is running on the compute device. The compute device can then operate with the new software as programmed. This can allow for new applications to run on the compute device, and thereby tailor operations and uses of the compute device. Also, the compute device can be reprogrammed where one program is removed and another one is installed, which allows for the compute device to update and change as needed or desired.

In some embodiments, the compute device can include a chemical sensor, biological sensor, or radiation sensor for monitoring an environment. As described herein, a network of the devices can be used for getting data from a test point to an analysis point. A network of vehicles (e.g., drones) with compute devices can be flown into a test area and staggered in a formation that allows the data to be transmitted from one device to another, repeated from the test site compute device to the analysis point compute device. Similarly, any type of network can be generated by distribution of the compute devices described herein, whether wearable on a subject or on a movable object (e.g., vehicle).

In some embodiments, the compute device can be configured with sensors such as optical, movement, or laser lines that can be used as tamper evident seals. Accordingly, the compute device can monitor if an asset is tampered with or otherwise compromised by other human or other entity. This configuration may also be useful for logistics and customs enforcement. For example, the customs enforcement configuration can have a sensor that reads a code (e.g., bar, QR, etc.) on a product, and then determines if the code belongs to an approved product or a counterfeit product. Other similar uses can be performed with the compute device.

The networks described herein can include one or more of the compute devices operating as one or more of endpoint devices, intermediate devices, network devices, or server devices. The compute device can operate in a communications method in the network. The method can include receiving a beacon into or from a first intermediate device via a first network, wherein the beacon was received by the first intermediate device from an endpoint device via a second network. The intermediate device or network component can identify a characteristic of the beacon, the characteristic of the beacon including an identifier of the endpoint device. The identifier of the endpoint device can be used to perform a lookup in a data record to identify a particular server that is associated with the beacon, which can be done by the intermediate device or network component. Optionally, the particular server for the beacon can be selected based on a result of the lookup in the data record. The intermediate device and/or network components can operate to send a beacon message to the server via a third network, where the beacon message can include at least one of the beacon, or information pertaining to the beacon. The intermediate device network can receive a response message pertaining to the beacon message from the server and then processing the response message. The beacon can include data identifying the endpoint device or data indicative of a geographical location of the endpoint device. The first network can be a longer-range network with corresponding communication channels, such as from mobile phone to server, compared to the second network of an endpoint device to mobile phone via Bluetooth.

In some aspects, the response message can be addressed to a second intermediate device. The response message can include an indication that the endpoint device has been found or identified or verified, or otherwise authenticated. The response message can include at least one instruction that is executable by the second intermediate device. The instruction can cause further propagation of the response message through the network, or cause propagation of authentication of the endpoint device. The instruction can also result in providing information about an operation parameter or location of the endpoint device. The processing of the response message can include sending the response message to the second intermediate device. In some aspects, the response message includes an instruction executable by the endpoint device, wherein processing the response message includes sending the response message to the endpoint device for execution.

In some embodiments, a method of sending a response message to the endpoint device can include identifying an intermediate device that is currently communicatively coupled to the endpoint device. The intermediate device can include the first intermediate device or a different second intermediate device, which can be determined by optimization of the network. The server or network can send the response message to the identified intermediate device with an instruction to forward the response message to the endpoint device.

In some embodiments, a network of the compute devices can reconfigure operation or track movement of a node from one position to another position. This can also include active tracking during movement of the node in the network. The method can include detecting movement of a first intermediate device from a first geographic location to a second geographic location. In response to the first intermediate device moving to the second geographic location, the first intermediate device can receive a beacon from an endpoint device. The beacon can include an identifier of the endpoint device. A relay server can be identified to send a beacon message, the beacon message including the identifier of the endpoint device and at least one of the beacon, or information pertaining to the beacon. The appropriate relay server can be selected using the beacon message. The first intermediate device can then send the beacon message with the identifier of the endpoint device to the relay server. Accordingly, the first intermediate device can be configured for listening for the beacon by periodically scanning for beacons via a first network, where the first intermediate device can be configured to receive the beacon from the endpoint device via the first network or any other network.

The beacon message can be sent from the endpoint device to the relay server in response to a determination that the first intermediate device is connected to a second network. The beacon message can be sent from the endpoint device to the relay server via the second network.

In some embodiments, the relay server can be identified to send the beacon message by various criteria. In some aspects, the network or intermediate device can determine its geographical location. Then, the relay server within range can be selected as the relay server for communication from a set of relay servers. The selected relay server can be the closest relay server to the geographic location of the first intermediate device from the set of relay servers. This can optimize data distribution through the network.

The independent device can receive a response message from the relay server pertaining to the beacon message, and then send the response message to the endpoint device. Sometimes, a second intermediate device may come into closer range and then be sent the response message, which second intermediate device then sends the response message to the endpoint device.

The network can also process communications by receiving, by an intermediate device, data from an endpoint device via a first network connection. The data can then be sent to a relay server via a second network connection. An endpoint manager server and via the relay server can process a particular response message pertaining to the data. The network can send the particular response message to the endpoint device, such as via an intermediate device. The intermediate device can be configured for listening for the data from the endpoint device, and then receiving the data from the endpoint device when available.

The network can include mobile nodes with allows for the mesh network, ad hoc network to have the intermediate device, wherein the data is received from the endpoint device in response to detecting the movement of the intermediate device. As such, the active listening for data from the endpoint device can continue until a predetermined event occurs or the intermediate device moves out of range of the endpoint device or a relay server. The configuration of the network allows for the message sent to the endpoint device in response to the endpoint device and the intermediate device being within wireless communication range of each other.

The intermediate device can also determine when to send a request for the particular response message to the relay server. Such a request for the response message can be responsive to a determination to send the request for the particular response message to the relay server. The relay server can be identified, and the request for the particular response message can be sent to the relay server.

In some embodiments, the compute device (e.g., intermediate device or server) can be configured for providing a service operation or an application to an endpoint device, directly or indirectly. The compute device can receive a request to register a service that is supported by the endpoint device. The compute device can analyze the application or service identified in the request and identify an application or service provider of interest that relates to the service. The compute device can receive a service connection request to initiate data flow related to the application or service to the endpoint device. Once the endpoint device is validated the application can be provided to the endpoint device for operation thereof. Alternatively, the service connection to a device associated with the service can be provided to the endpoint device once validated.

In some embodiments, the network can facilitate secure communications by using secure beacons and establishing secure beacon identity. A beacon can be received from a first intermediate device via a first network. The beacon can be received by the first intermediate device from an endpoint device via a second network. The beacon can include a hash value based at least in part on the identity of the endpoint device and a time unit when the beacon was generated. The hash value of the beacon can be validated based on the identity of the endpoint device and the time unit when the beacon was generated. The beacon can be forwarded to a server via a third network in response to the hash value of the beacon being valid. Also, one or more hash values can be invalidated that have a time unit that is earlier than a latest resolved time. This allows for increases security of the network.

In some embodiments, a method of validating the hash value of the beacon can be performed. The hash values can be precomputed for one or more unique device identities and for values of time units up to a fixed time value, and then stored. The hash value received with the beacon can be compared with the stored precomputed hash values. When matching, the hash value of the beacon can be validated in response to the hash value received with the beacon matching one of the stored precomputed hash values. When they do not match, the has value can be invalidated, which can invalidate the beacon and stop a beacon message from propagating through the network.

In some embodiments of validation, the hash values can be calculated for a set of unique device identities and for values of time units up to a fixed time value, and then saved. A beacon from a first intermediate device can be received via a first network. The beacon can be received by the first intermediate device from an endpoint device via a second network. The beacon can have a hash value based at least in part on the identity of the endpoint device and a time unit when the beacon was generated. The hash value received with the beacon can be compared with the stored precomputed hash values. A hash value of the beacon can be validated in response to the hash value received with the beacon matching one of the stored precomputed hash values as a result of the identity of the endpoint device and the time unit when the beacon was generated. Otherwise, the hash value is not validated. Any stored computed hash values for time unit values whose difference from the current time is greater than a predetermined threshold value can be deleted. The validated beacon can be forwarded to a server via a third network in response to the hash value of the beacon being valid. Also, a clock drift of the endpoint device can be calculated wherein the clock drift is based on at least one of a temperature of a timing crystal of the endpoint device, a crystal frequency deviation, or an elapsed time since a last clock synchronization. The time unit can be adjusted based on the calculated clock drift. The hash value of the beacon can be validated based on the identity of the endpoint device and the time unit when the beacon was generated and the beacon can be sent to a server via a third network in response to the hash value of the beacon being valid.

In some embodiments, the compute device can be used in a mobile ad hoc network. Each compute device in a mobile ad hoc network is free to move independently in any direction, and will therefore change its links to other devices frequently. Each compute device can be configured to forward traffic unrelated to its own use, and therefore be a router. The ability of the compute device to be configurable for each use enables building a mobile ad hoc network with some of the compute devices being frequently mobile and movable. Each compute device can be equipped to continuously maintain the information required to properly route traffic. Such mobile ad hoc network may operate by themselves or may be connected to the larger Internet. They may contain one or multiple and different compute device operating as transceivers between nodes. This results in a highly dynamic, autonomous topology. The mobile ad hoc network can have a routable networking environment on top of a link layer ad hoc network.

In some embodiments, a compute device can include a substrate, at least one circuit trace, electronic components, at least one power source, at least one antenna layer, and a coupling member. The substrate can be any type of substrate used in electronic devices for receiving electronic circuit traces and electronic components thereon, which can be a traditional rigid PCB or a flexible layer of paper or polymeric material that can receive the electronics thereon. The compute device can include at least one circuit trace on the substrate that is electronically coupled to electronic components. The electronic components include at least a processor, memory, and transceiver as well as other electronic components in computing devices. The compute device can include at least one power source that is operationally coupled with the electronic components, which provides the power for operation. The compute device can include at least one antenna layer over the substrate that has at least one primary antenna element of at least one antenna assembly therein. Each antenna assembly can be operationally coupled with the transceiver as a data communication link. Each primary antenna element can be operationally coupled to at least one of the electronic components or power source as a structure of at least one ground plane for the respective primary antenna element. A coupling member is included that is configured for being coupled to an object. The at least one power source aspects, the at least one ground plane includes the battery; the at least one ground plane includes the solar element; or the at least one ground plane includes the solar element and battery.

The compute device can include various configurations as described herein, such as a layered configuration. The solar element can be between the antenna layer and substrate. The primary antenna element is optically transmissive to let light pass therethrough to the solar element. In some aspects, the battery is between at least one antenna layer and substrate. In some aspects, the battery and solar element are arranged in a stacked arrangement with the antenna layer being on top with the battery between the solar element and substrate. In some aspects, a plurality of vias that are electronically connected to electrically conductive elements of the at least one circuit trace, electronic components, solar element, antenna, or battery. In some aspects, the battery can include an anode on one layer and a cathode on a different layer, which are connected by vias. In some aspects, at least one of the battery or solar element is on the substrate with the at least one circuit trace. In some aspects, both the battery and solar element are on the substrate with the at least one circuit trace. In some aspects, a transparent insulation layer between the antenna layer and solar element.

In some embodiments, the compute device can include at least one sensor. The sensors can be selected from a flex sensor, temperature sensor, humidity sensor, radiation sensor, motion sensor, compass, light sensor, camera sensor, sound sensor, chemical sensor, biological sensor, or combinations thereof.

In some embodiments, an operating system installed and operational on the compute device. The operating system can allow for enhanced functionality and operation of applications.

The coupling member can be any type of coupling device or system as well as fastener systems that fasten objects together. In some instances, the coupling member mounts the compute device to a surface of an object. The coupling member can be selected from an adhesive layer, magnetic layer, hook and loop fastener, or combination thereof. In some aspects, the coupling member includes at least one aperture (e.g., at a corner or in a flange or other member) for receiving a fastening member therethrough to couple with the object. The fastening member can be any type traditionally used in construction or mounting that couples two objects together, such as mounting a smaller object (e.g., compute device) to a large object (e.g., wall of building). In some aspects, the substrate is flexible such that the compute device can bend to couple to surfaces that are curved or have bends. The coupling member can be coupled to the object during use, such as in a network.

In some embodiments, a method of operating an edge server is provided. The method can include providing the compute device of one of the embodiments that is configured as an edge server in a network. The method can include operating the compute device as an edge server to perform an operation. Edge server operation is known and incorporated herein. The device can include the hardware and software to operate as an edge server. In some aspects, the edge server configuration of the compute device can be used for performing at least one of computations, networking, storage, or security functions. In some aspects, the edge server configuration of the compute device can be used for performing neural network operations. Neural network operations are known and incorporated herein. During operation as an edge server, the method can include obtaining a result of the operation with the compute device, and transmitting the result of the operation to a network device in the network. In some aspects, the network device in the network is a second compute device.

In some embodiments, a method of operating a base station is provided. The method can include providing the compute device of one of the embodiments that is configured as a base station in a network. The method can include operating the compute device as the base station to perform an operation. Base station operation in a network is known an incorporated herein. The base station configuration of the compute device can be used for performing base station functions in the network. The base station can facilitate a connection operation to connect a first compute device to a second compute device via the network. The base station can facilitate a switching operation to switch a connection of a first compute device from a second compute device to a third compute device. The base station can facilitate a connection operation to connect a first compute device to a local area network or Internet. The base station can facilitate a switching operation to switch a connection of a first compute device from a first network to a second network. In some aspects, the network is a mesh network, but can be any other type of network whether recited herein or otherwise known.

In some embodiments, the compute device can be used for performing a backhaul operation in the network. The compute device can be used for providing a point of access to a second network. The compute device can be operated as part of a multiple-input and multiple-output array with a plurality of network devices in the network. The compute device can be operated to connect a ground-based network with at least one other ground-based network or satellite network.

In some embodiments, a method of broadcasting telemetry can be performed. The method can include providing the compute device of one of the embodiments, where the compute device includes telemetry data in the memory. The method can include transmitting the telemetry data to at least one network device in a network. Telemetry data is well known and incorporated herein. For example, the telemetry data can be operational data of the compute device. In another example, the telemetry data is operational data of a second compute device or different device or instrument that can wirelessly communicate with the compute device to provide the telemetry data. The method can also include obtaining the telemetry data from an instrument. In some aspects, the instrument obtained the telemetry data regarding operation of itself or a network device in the network, which is then provided to the compute device.

In some embodiments, a method of operating an application can be performed. The method can include providing the compute device of one of the embodiments. The compute device can include an application in the memory. The application can be operated by the compute device with data to obtain application data. The application data can then be transmitted to the network device in a network. The application can include executable instructions for collecting data from the compute device or a second device. The application can include executable instructions for processing the data to obtain the application data. The application can include executable instructions for transmitting the application data as output data. The method can also include uploading the application from an application providing device to the compute device. If the compute device includes the application, then the application can be installed on the compute device for use.

In some embodiments, a method of communicating in a network can be performed. The method can include providing the compute device of one of the embodiments connected to a network. The compute device can operate in the network by transmitting data from the compute device to a network device on the network. The compute device can be configured as an endpoint device. The endpoint device configuration can perform the following communication protocol: obtaining data with the compute device; transmitting a beacon to an intermediate device in the network; validating the beacon; transmitting a response message to the endpoint device; and transmitting the obtained data to the intermediate device. The compute device can also obtain the data via a sensor of the compute device. The compute device can be used for processing measurement data to obtain the data that is transmitted. Also, the compute device can obtain the data from a network device in the network. The compute device can also obtain measurement data from a network device in the network. Once the data is obtained, the compute device can process the measurement data to obtain the data that is transmitted.

In some embodiments, the compute device can be configured as an intermediate device. When an intermediate device, a communication method can include: receiving a beacon from an endpoint device in the network; validating the beacon; transmitting a response message to the endpoint device; and transmitting the data to the intermediate device. The intermediate device configuration can also transmit a beacon to a server in the network from the intermediate device, where the beacon is validated. Then, the server can transmit a response message to the intermediate device, which response message can indicate the server will receive the data from the intermediate device. The data can then be transmitted from the intermediate device to the server.

In some embodiments, the compute device is configured as a server. Accordingly, a method of communications on a network with a compute device server can include: receiving a beacon from an intermediate device in the network; validating the beacon; transmitting a response message from the server to the intermediate device; and transmitting the obtained data from the intermediate device to the server. Also, other server operations can be performed.

In some embodiments, a method of monitoring an environment can be performed. Such an environment monitoring method can include providing the compute device of one of the embodiments that includes at least one sensor. The method can include monitoring the environment with the at least one sensor to obtain at least one type of sensor data. The monitoring can include transmitting the at least one type of sensor data to a network device in a network. The network device can analyze the data or pass the data along to another node or compute device in the network. Any sensor may be included. Also, the sensor may be included in another instrument. The sensor can be a temperature sensor, humidity sensor, radiation sensor, motion sensor, compass, light sensor, camera sensor, sound sensor, chemical sensor, biological sensor, or combination thereof. The method can include processing raw sensor data from the at least one sensor to obtain the at least one type of sensor data that is transmitted, which can be by the compute device. For example, the sensor functions can include one or more of obtaining temperature data with the temperature sensor; obtaining humidity data with the humidity sensor; obtaining radiation data with the radiation sensor; obtaining motion data with the motion sensor; obtaining direction data with the compass; obtaining light data with the light sensor; obtaining sound data with the sound sensor; obtaining image data with the camera sensor; obtaining chemical data with the chemical sensor; or obtaining biological data with the biological sensor.

In some embodiments, a method of securing identity of an object can be performed. The method can be performed with the compute device configured with security software. An object can be provided so that the compute device can generate a unique identifier for the object. The compute device can store the unique identifier in the memory. Also, the compute device can associate the unique identifier with the object. The compute device can also include the unique identifier for the object in memory. In some aspects, the object is an article of manufacture and the compute device is mounted to the article of manufacture or mounted in packaging containing the article of manufacture. In some aspects, the object is a shipping object (e.g., package, pallet, container, etc.) and the compute device is mounted to the object.

In some aspects, the security method can include receiving a request for the unique identifier from a second compute device; providing the unique identifier to the second compute device; and authenticating the object with the unique identifier by the second compute device. Also, the method can include: broadcasting the unique identifier from a first compute device; listening, with an authenticating device, for a unique identifier; obtaining the unique identifier from the broadcast; and authenticating the object with the unique identifier by the authenticating device.

In some embodiments, a method of providing a hosting service can be performed. The method can include providing the compute device of one of the embodiments connected to a network. Data can be stored on the memory of the compute device. A request can be received from a network device on the network for the stored data. In response, the method can include providing the stored data from the compute device to the network device on the network in response to the request. In some aspects, the compute device performs a hosting service for a local network. In some aspects, the compute device performs a hosting service for a decentralized network. In some aspects, the compute device is a node in a blockchain, and the data is blockchain data. In some aspects, the blockchain data includes cryptocurrency data. In some aspects, the compute device is awarded cryptocurrency monetary units for operating with the cryptocurrency data.

In some embodiments, the compute device can be configured as a virtual machine. In some aspects, the data stored on the memory of the compute device is an operating system. In some aspects, the compute device is a virtual machine for the network device on the network. A method for operating a virtual machine can include: providing a command by the network device on the network to the virtual machine; executing the command by the virtual machine to obtain results; and transmitting the results to the network device on the network.

In some embodiments, a method of determining a relative geographic position in a network can be performed. The method can include providing the compute device of one of the embodiments connected to a network. Data can be received into the compute device from at least one network device in the network. The data can include at least one of time of flight, signal strength, phase shift, or angle of arrival from the at least one network device in the network. A relative geographic position of the compute device can be determined in the network from the at least one network device by processing the data of at least one of time of flight, signal strength, phase shift, or angle of arrival from the at least one network device on the network. In some aspects, the relative geographic position of the compute device can be transmitted to the at least one network device or different network device. In some aspects, a step of determining a relative geographic position of the at least one network device in the network from the compute device can be performed by processing the data of at least one of time of flight, signal strength, phase shift, or angle of arrival from the at least one network device in the network. In some aspects, the relative geographic position of the at least one network device can be transmitted to the at least one network device.

In some embodiments, a method of providing verifying health data of a subject can be performed with a compute device. The method can include transmitting health data to the compute device, and inputting health data into the memory of the compute device. A cryptographic code can be generated for the health data with the compute device. The cryptographic code for the health data can be transmitted in the network. A receiving network device, such as a compute device, can operate by decrypting the cryptographic code for the health data. Once decrypted, the verification of the health data can be performed. In some aspects, the health data is for a subject and provides information about a health status of the subject. In some aspects, the health status is a definition of whether or not the subject has a condition. In some aspects, the condition is selected from a disease, an infection, a pregnancy, a malfunctioning organ, a broken bone, a physiological abnormality, presence of a biomarker, or a wellbeing of the subject. For example, the compute device can be operatively coupled with a genetic sequencer device or configured as a genetic sequencer device to provide gene sequence data.

In some embodiments, a method of monitoring for tampering with an object can be performed. The method can include providing the compute device of one of the embodiments having an application installed thereon that is adapted for monitoring tampering activity. The method can include associating the compute device with an object, wherein the compute device is programmed to monitor the object for tampering. The tampering activity can be monitored with the compute device to obtain tamper data. The tamper data can then be used for a determination of whether or not the object has been tampered with. Also, the method can include transmitting the tamper data from the compute device. An example tampering protocol can include: receiving the tamper data from the compute device; analyzing the tamper data; determining whether or not the tamper data indicates that the object was tampered with; and one of when the object was tampered with, identify the object as being tampered with; or when the object was not tampered with, identifying the object as being untampered with.

A method of role switching of compute devices can be performed in a network. The method can include: providing the compute device of one of the embodiments in a network, wherein the compute device is operating as a first type of network device; determining that the compute device is to be changed to a second type of network device; and changing the compute device to the second type of network device in the network.

In some embodiments, the switching method can also include: monitoring operation of the network; monitoring relative operation of the compute device in the network; determining that a second type of network device at the compute device increases operation of the network in at least one parameter; and causing the compute device to change to the second type of network device on the network. The compute device can be configured for determining the change from the first type of network device to the second type of network device based on operation of the compute device or interaction of the compute device with the network.

In some embodiments, a network device switching method may also include: monitoring the operation of the compute device with a monitoring device; identifying the at least one parameter in operation of the compute device; determining an improvement in operation of the network by modifying the at least one parameter; and modifying the at least one parameter to cause the change from the first type of network device to the second type of network device based on operation of the compute device or interaction of the compute device with the network.

In some embodiments, the network device switching method can include: monitoring intermediate devices, network components, and/or servers in the network; identifying the network omitting one of an intermediate device, a network component, or a server in a defined geographical region of the network; identifying the compute device as a candidate to be the intermediate device, network component, or server in the defined geographical region of the network; and switching the compute device to be the intermediate device, network component, or server in the defined geographical region of the network from the first type of network device. In some aspects, the switching method can include: the compute device being one of an intermediate device, network component, or server in the defined geographical region of the network; and switching the compute device to be one of the intermediate device, network component, or server in the defined geographical region of the network from the first type of network device.

In some embodiments, a network device switching method can include: monitoring intermediate devices, network components, and/or servers in the network; identifying the network having a malfunctioning network device that is one of an intermediate device, network component, or server in a defined geographical region of the network; identifying the compute device as a candidate to be a replacement for the malfunctioning network device, wherein the compute device is in the defined geographical region of the network; and switching the compute device to be the replacement for the malfunctioning network device, and changing the compute device to be the intermediate device, network component, or server in place of the malfunctioning network device in the defined geographical region of the network.

In some embodiments, applications can be uploaded to a compute device for switching roles in a network. The method can include: analyzing applications on the compute device; determining the compute device needs an application to operate as one of the intermediate device, network component, or server; transmitting the application to the compute device; and switching the compute device, with the application, to be the intermediate device, network component, or server from the first type of network device.

In some embodiments, a compute device can include the memory having one or more non-transitory computer readable media storing instructions that in response to being executed by one or more processors, cause a computer system to perform operations, the operations comprising the method from one of the embodiments provided herein.

In some embodiments, a network can include at least one compute device connected to a network of network devices. Also, the network can include at least two compute devices connected to a network. The memory can include one or more non-transitory computer readable media storing instructions that in response to being executed by one or more processors, cause a computer system to perform operations, the operations comprising the method from one of the embodiments provided herein. In some aspects, the at least one compute device is coupled with an object. In some aspects, the compute device has an adhesive layer adhered to a surface of the object. In some aspects, the surface of the object is curved and the compute device bends to the curve of the surface of the object. In some aspects, a plurality of compute devices coupled to a plurality of different objects. In some aspects, the plurality of different objects are selected from buildings, trees, utility poles, pallets, cargo containers, packages, land vehicles, air vehicles, and space vehicles.

One skilled in the art will appreciate that, for the processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In one embodiment, the present methods can include aspects performed on a computing system. As such, the computing system can include a memory device that has the computer-executable instructions for performing the methods. The computer-executable instructions can be part of a computer program product that includes one or more algorithms for performing any of the methods of any of the claims.

In one embodiment, any of the operations, processes, or methods, described herein can be performed or cause to be performed in response to execution of computer-readable instructions stored on a computer-readable medium and executable by one or more processors. The computer-readable instructions can be executed by a processor of a wide range of computing systems from desktop computing systems, portable computing systems, tablet computing systems, hand-held computing systems, as well as network elements, and/or any other computing device. The computer readable medium is not transitory. The computer readable medium is a physical medium having the computer-readable instructions stored therein so as to be physically readable from the physical medium by the computer/processor.

There are various vehicles by which processes and/or systems and/or other technologies described herein can be effected (e.g., hardware, software, and/or firmware), and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The various operations described herein can be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware are possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a physical signal bearing medium include, but are not limited to, the following: a recordable type medium such as a floppy disk, a hard disk drive (HDD), a compact disc (CD), a digital versatile disc (DVD), a digital tape, a computer memory, or any other physical medium that is not transitory or a transmission. Examples of physical media having computer-readable instructions omit transitory or transmission type media such as a digital and/or an analog communication medium (e.g., a fiber optic cable, a waveguide, a wired communication link, a wireless communication link, etc.).

It is common to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. A typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems, including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. Such depicted architectures are merely exemplary, and that in fact, many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include, but are not limited to: physically mateable and/or physically interacting components and/or wirelessly interactable and/or wirelessly interacting components and/or logically interacting and/or logically interactable components.

FIG. 6 shows an example computing device 600 (e.g., a computer) that may be arranged in some embodiments to perform the methods (or portions thereof) described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including, but not limited to: a microprocessor (μP), a microcontroller (μC), a digital signal processor (DSP), or any combination thereof. Processor 604 may include one or more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations, memory controller 618 may be an internal part of processor 604.

Depending on the desired configuration, system memory 606 may be of any type including, but not limited to: volatile memory (such as RAM), non-volatile memory (such as ROM, flash memory, etc.), or any combination thereof. System memory 606 may include an operating system 620, one or more applications 622, and program data 624. Application 622 may include a determination application 626 that is arranged to perform the operations as described herein, including those described with respect to methods described herein. The determination application 626 can obtain data, such as pressure, flow rate, and/or temperature, and then determine a change to the system to change the pressure, flow rate, and/or temperature.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include: magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include: volatile and non-volatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to: RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In some embodiments, a computer program product can include a non-transient, tangible memory device having computer-executable instructions that when executed by a processor, cause performance of a method that can include: providing a dataset having object data for an object and condition data for a condition; processing the object data of the dataset to obtain latent object data and latent object-condition data with an object encoder; processing the condition data of the dataset to obtain latent condition data and latent condition-object data with a condition encoder; processing the latent object data and the latent object-condition data to obtain generated object data with an object decoder; processing the latent condition data and latent condition-object data to obtain generated condition data with a condition decoder; comparing the latent object-condition data to the latent-condition data to determine a difference; processing the latent object data and latent condition data and one of the latent object-condition data or latent condition-object data with a discriminator to obtain a discriminator value; selecting a selected object from the generated object data based on the generated object data, generated condition data, and the difference between the latent object-condition data and latent condition-object data; and providing the selected object in a report with a recommendation for validation of a physical form of the object. The non-transient, tangible memory device may also have other executable instructions for any of the methods or method steps described herein. Also, the instructions may be instructions to perform a non-computing task, such as synthesis of a molecule and or an experimental protocol for validating the molecule. Other executable instructions may also be provided.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

All references recited herein are incorporated herein by specific reference in their entirety.

1. A method of performing an operation with a compute device, the method comprising:
providing a compute device comprising:
a substrate;
at least one circuit trace on the substrate that is electronically coupled to electronic components, wherein the electronic components include at least a processor, memory, and transceiver;
at least one power source operationally coupled with the electronic components;
at least one antenna layer over the substrate that has at least one primary antenna element of at least one antenna assembly, wherein each antenna assembly is operationally coupled with the transceiver as a data communication link, and each primary antenna element is operationally coupled to at least one of the electronic components or power source as a structure of at least one ground plane for the respective primary antenna element; and
a coupling member configured for being coupled to an object,
wherein the memory includes one or more non-transitory computer readable media storing instructions that in response to being executed by one or more processors, cause a computer system to perform operations of an application, the operations comprising a method of performing a computation with the application on the compute device; and
performing the computation with the application on the compute device.

2. A method of operating an edge server, comprising:
performing the method of claim 1, wherein the compute device is configured as an edge server in a network; and
operating the compute device as an edge server to perform an operation.

3. The method of claim 2, further comprising the edge server configuration of the compute device performing at least one of computations, networking, storage, and security functions.

4. The method of claim 3, further comprising the edge server configuration of the compute device performing neural network operations.

5. The method of claim 2, further comprising:
obtaining a result of the operation with the compute device; and
transmitting the result of the operation to another device in the network.

6. A method of operating a base station, comprising:
performing the method of claim 1, wherein the compute device is configured as a base station in a network; and
operating the compute device as a base station to perform an operation.

7. The method of claim 6, further comprising the base station configuration of the compute device performing at least one of:
a connection operation to connect a first compute device to a second compute device via the network;
a switching operation to switch a connection of a first compute device from a second compute device to a third compute device;
a connection operation to connect a first compute device to a local area network or Internet; or
a switching operation to switch a connection of a first compute device from a first network to a second network.

8. The method of claim 7, wherein the network is a mesh network.

9. The method of claim 7, further comprising at least one of:
the compute device performing a backhaul operation in the network;
the compute device providing a point of access to a second network;
the compute device operating as part of a multiple-input and multiple-output array with a plurality of other compute devices; or
the compute device operating to connect a ground-based network with at least one terrestrial network or satellite network.

10. A method of broadcasting telemetry, comprising:
performing the method of claim 1, wherein the compute device includes telemetry data in the memory; and
transmitting the telemetry data to at least one other device on a network.

11. A method of monitoring an environment, comprising:
performing the method of claim 1, wherein the compute device includes at least one sensor;
monitoring the environment with the at least one sensor;
obtaining at least one type of sensor data; and
transmitting the at least one type of sensor data to another device on a network.

12. A method of securing identity of an object, comprising:
performing the method of claim 1;
providing an object;
generating a unique identifier for the object with the compute device;
storing the unique identifier in the memory; and
associating the compute device with the object, wherein the compute device includes the unique identifier for the object in memory.

13. A method of providing a hosting service, comprising:
performing the method of claim 1, wherein the compute device is connected to a network;
storing data on the memory of the compute device;
receiving a request from a device on the network for the stored data; and
providing the stored data from the compute device to the device on the network in response to the request.

14. A method of determining a relative geographic position in a network, comprising:
performing the method of claim 1, wherein the compute device is connected to a network;
receiving data into the compute device from at least one network device on the network, wherein the data includes at least one of time of flight, signal strength, phase shift, or angle of arrival from the at least one network device on the network;
determining a relative geographic position of the compute device in the network from the at least one network device by processing the data of at least one of time of flight, signal strength, phase shift, or angle of arrival from the at least one network device on the network; and
transmitting the relative geographic position of the compute device to the at least one network device.

15. A method of providing verifying health data of a subject, comprising
performing the method of claim 1, further comprising at least one of:
transmitting health data to the compute device;
inputting health data into the memory of the compute device;
generating a cryptographic code for the health data with the compute device;
transmitting the cryptographic code for the health data;
decrypting the cryptographic code for the health data; and
verifying the health data from the decryption.

16. A method of monitoring tampering with an object, comprising;
performing the method of claim 1, wherein the application is adapted for monitoring tampering activity;
associating the compute device with an object, wherein the compute device is programmed to monitor the object for tampering;
monitoring for tampering activity with the compute device to obtain tamper data; and
transmitting the tamper data from the compute device.

17. A method of role switching in a network, comprising:
performing the method of claim 1, wherein the compute device is in a network and operating as a first type of network device;
determining that the compute device is to be changed to a second type of network device; and
changing the compute device to the second type of network device in the network.
